(19) United States
(12) Patent Application Publication
(10) Pub. No.: US 2026/0197577 A1
(43) Pub. Date: Jul. 9, 2026

(54) EARPHONE AND AUDIO APPARATUS

(71) Applicant: HUAWEI TECHNOLOGIES CO., LTD., Shenzhen (CN)

(72) Inventors: Guangxing Zhang, Dongguan (CN); Meiqiang Li, Dongguan (CN); Yining Zhang, Shanghai (CN); Huarong Xie, Dongguan (CN); Shaopeng Yang, Dongguan (CN); Liang Li, Dongguan (CN); Xianchun Zhang, Dongguan (CN); Jiong Ding, Dongguan (CN)

(73) Assignee: HUAWEI TECHNOLOGIES CO., LTD., Shenzhen (CN)

(21) Appl. No.: 19/554,314

(22) Filed: Mar. 2, 2026

Related U.S. Application Data
(63) Continuation of application No. PCT/CN2024/115705, filed on Aug. 30, 2024.

(30) Foreign Application Priority Data
Sep. 1, 2023 (CN) 202311138097.8
Apr. 9, 2024 (CN) 202410425655.7

(51) Int. Cl. H04R 1/10

(52) U.S. Cl. CPC H04R 1/1058; H04R 1/1016

(57) ABSTRACT

An earphone includes a first earphone body, a connecting arm, and a second earphone body, where the connecting arm is connected to the first earphone body and the second earphone body. A center of an outer surface of the first earphone body, a center of an outer surface of the second earphone body, and a center of an outer surface of the connecting arm are connected to each other to form a symmetry plane. First and second vent holes in the earphone are symmetrical with respect to the symmetry plane. A main antenna unit and a parasitic antenna unit in the earphone is symmetrical with respect to the symmetry plane.

### CROSS-REFERENCE TO RELATED APPLICATIONS

This is a continuation of International Application No. PCT/CN2024/115705 filed on Aug. 30, 2024, which claims priority to Chinese Patent Application No. 202311138097.8 filed on Sep. 1, 2023 and Chinese Patent Application No. 202410425655.7, filed on Apr. 9, 2024. All of the aforementioned patent applications are hereby incorporated by reference in their entireties.

### TECHNICAL FIELD

Disclosed embodiments relate to the earphone field, and in particular, to an earphone and an audio apparatus.

### BACKGROUND

Clip-on wireless earphones can be attached to the ears of a user to reduce ear canal allergies and damage. Clip-on wireless earphones allow users to always perceive changes in their surroundings, lowering accident risks, making them suitable for long-term wear in exercise, commuting, and daily work and life. The clip-on wireless earphones include a left earphone and a right earphone. Sound pickup holes on both the left earphone and the right earphone need to face away from the ground, to ensure optimal sound pickup effect. When wearing the earphones, users need to distinguish between the left and right earphone.

### SUMMARY

This disclosure provides an earphone and an audio apparatus.

According to a first aspect, an earphone is provided that includes a first earphone body, a connecting arm, and a second earphone body, where the connecting arm is connected to the first earphone body and the second earphone body. The second earphone body includes a housing, the housing has a first sound pickup hole and a second sound pickup hole, the first sound pickup hole and the second sound pickup hole are connected to an interior of the housing, and the first sound pickup hole and the second sound pickup hole are configured to pick up external sound of the second earphone body. A center of an outer surface of the first earphone body, a center of an outer surface of the second earphone body, and a center of an outer surface of the connecting arm are connected to each other to form a symmetry plane. The first sound pickup hole and the second sound pickup hole are spaced from each other in a first direction. The first direction is perpendicular to the symmetry plane. The first sound pickup hole and the second sound pickup hole are symmetrical with respect to the symmetry plane.

It may be understood that when the user wears the earphone, the first earphone body may be clipped in a concha cavity of the user, and the second earphone body is located on a side that is outside an ear of the user and that is away from the first earphone body. The connecting arm is buckled to an outer edge side of the ear of the user, and extends from the concha cavity to a back position of the ear. The connecting arm may clamp an auricle of the user together with the first earphone body and the second earphone body, to wear the earphone on the ear. A center of an outer surface of the first earphone body, a center of an outer surface of the second earphone body, and a center of an outer surface of the connecting arm are connected to each other to form a symmetry plane, and the symmetry plane may be approximately perpendicular to the ear of the user.

In comparison with a solution in which only one sound pickup hole is disposed, in this application, both the first sound pickup hole and the second sound pickup hole are disposed. When one of the first sound pickup hole and the second sound pickup hole is blocked by sweat or dust, the other sound pickup hole can work normally.

In comparison with a technical solution in which only one of the first sound pickup hole and the second sound pickup hole is disposed, in this application, the first sound pickup hole and the second sound pickup hole are spaced from each other in a first direction, and the first direction is perpendicular to the symmetry plane. The first sound pickup hole and the second sound pickup hole are symmetrically disposed with respect to the symmetry plane. The first sound pickup hole and the second sound pickup hole may be respectively located on two sides of the symmetry plane. When a microphone in the second earphone picks up external sound through the first sound pickup hole and the second sound pickup hole for active noise reduction or a call, regardless of whether the user wears the earphone on the right ear or the left ear, one of the first sound pickup hole and the second sound pickup hole always faces the ground, and the other sound pickup hole faces a side away from the ground. Interference effects received in a sound pickup process are consistent, and do not change due to a change of a space position. Sound pickup effect of the second earphone body is basically consistent. Sound output effect of the earphone is also basically consistent. In addition, when the user uses the earphones, regardless of whether the user wears the earphones on the right ear or the left ear, positions of the first sound pickup hole and the second sound pickup hole are the same. When using the earphones, the user does not need to distinguish between the right ear and the left ear.

In a possible implementation, the second earphone body includes a long axis, and the long axis is a connection line between two farthest endpoints of a housing of the second earphone body in the first direction. The first sound pickup hole and the second sound pickup hole are located on a side that is of the long axis and that is close to the connecting arm.

It may be understood that when the user wears the earphone, a direction of the long axis may be approximately perpendicular to a ground direction. When sweat drops onto the housing of the second earphone in a process in which the user wears the earphone, in comparison with a solution in which the first sound pickup hole and the second sound pickup hole are disposed on the long axis, the first sound pickup hole and the second sound pickup hole are disposed on a side that is of a long axis L1 and that is close to the connecting arm, so that the sweat may slide in a curve of the housing. This can reduce a risk that the sweat directly drops into the first sound pickup hole or the second sound pickup hole. A case in which the first sound pickup hole or the second sound pickup hole is blocked by the sweat, thereby affecting sound pickup effect of the first sound pickup hole or the second sound pickup hole is avoided.

When the user wears the earphone, the second earphone body is located on a side that is outside an ear of the user and that is away from the first earphone body. The connecting arm is buckled to the outer edge side of the ear of the user, and extends from the concha cavity to the back position of the ear. In comparison with a solution in which the first sound pickup hole and the second sound pickup hole are disposed on a side that is of the long axis and that is away from the connecting arm, the first sound pickup hole and the second sound pickup hole are disposed on a side that is of the long axis and that is close to the connecting arm, the first sound pickup hole and the second sound pickup hole are farther from the skin of the user, and there is less blocking around the position. When the microphone in the second earphone body picks up sound through the first sound pickup hole and the second sound pickup hole, there is less external blocking.

In a possible implementation, the housing of the second earphone body has a first connecting hole, the first connecting hole and the first sound pickup hole are spaced, and the first connecting hole allows an end part of the connecting arm to extend into the second earphone body.

In the first direction, a projection of a center of the first sound pickup hole on the symmetry plane is a first projection, a projection of a center of the first connecting hole on the symmetry plane is a second projection, a distance between the first projection and the second projection is A1, and a distance between the second projection and the center of the outer surface of the second earphone body is A2.

A relationship between A1 and A2 satisfies:

$$A 1 < \frac{1}{2} \times A 2 .$$

It may be understood that when the user wears the earphone, the second earphone body is located on a side that is outside an ear of the user and that is away from the first earphone body. The connecting arm 300 is buckled to the outer edge side of the ear of the user, and extends from the concha cavity to the back position of the ear. A distance between the position of the first sound pickup hole and the connecting arm is less than a distance between the first sound pickup hole and the skin of the user, and there is less blocking around the position of the first sound pickup hole. When the microphone in the second earphone body picks up sound through the first sound pickup hole, there is less external blocking.

In a possible implementation, the second earphone body includes a first feedforward microphone and a second feedforward microphone. The first feedforward microphone and the second feedforward microphone are disposed inside the housing. The first feedforward microphone picks up external sound of the second earphone body through the first sound pickup hole, and the second feedforward microphone picks up external sound of the second earphone body through the second sound pickup hole. The first feedforward microphone and the second feedforward microphone are symmetrical with respect to the symmetry plane.

It may be understood that the first feedforward microphone and the second feedforward microphone may be configured to actively cancel noise of the earphone. Active noise cancelling is a method of identifying an unwanted sound source as noise, and eliminating the original noise by generating an “anti-noise” signal, to eliminate noise in real time. When the user uses the earphone, the user hears low noise in the sound emitted by the earphone. Therefore, user experience is better. The first feedforward microphone and the second feedforward microphone are symmetrically disposed with respect to the symmetry plane. Regardless of whether the user wears the earphone on the right ear or the left ear, noise information received when the first feedforward microphone and the second feedforward microphone pick up noise does not differ greatly, and active noise cancelling effect of the earphone is basically consistent. In this way, when the user uses the earphone, regardless of whether the user wears the earphone on the right ear or the left ear, sound output effect of the earphone is basically consistent.

In a possible implementation, the second earphone body has a first pipe, the first pipe is located inside the housing, the first pipe communicates with the first sound pickup hole, and a sound pickup surface of the first feedforward microphone is disposed opposite to the first pipe. The first pipe is curved.

It may be understood that when airflow near the first sound pickup hole passes through the first pipe, the curved pipe may buffer the airflow, and wind noise is small when the first feedforward microphone picks up sound through the first pipe.

In a possible implementation, the second earphone body includes a first bracket, the first bracket is fastened inside the housing of the second earphone body, the first feedforward microphone is fastened on the first bracket, and the first pipe is located on the first bracket.

It may be understood that, in comparison with a solution in which the first pipe is directly disposed on the housing of the second earphone body, disposing the first pipe on the first bracket helps reduce difficulty in forming the housing of the second earphone body, and facilitates replacement and maintenance of an internal component of the second earphone body. The first bracket may be configured to bear the first feedforward microphone. The first feedforward microphone may be first assembled on the first bracket, and then the first feedforward microphone and the first bracket are assembled into the housing of the second earphone body as a whole. This facilitates assembly of the second earphone body.

In a possible implementation, the first earphone body includes a housing and a first capacitive sensor, the first capacitive sensor is disposed inside the housing of the first earphone body, the second earphone body includes a second capacitive sensor and a controller, the second capacitive sensor and the controller are both disposed inside the housing of the second earphone body, and the first capacitive sensor and the second capacitive sensor are electrically connected to the controller. The first capacitive sensor is configured to obtain a first capacitance value in a first environment, the second capacitive sensor is configured to obtain a second capacitance value in a second environment, and the controller is configured to determine, based on the first capacitance value and the second capacitance value, whether the user wears the earphone.

It may be understood that, in comparison with a solution in which only the first capacitive sensor or the second capacitive sensor is disposed, in this application, the first capacitive sensor is disposed on the first earphone body, and the second capacitive sensor is disposed on the second earphone body. The controller may determine a status of the earphone based on absolute values and relative values of capacitance generated by the first capacitive sensor and the second capacitive sensor. In this way, a risk of a false touch can be reduced, and wearing detection precision of the earphone can be improved.

In a possible implementation, the outer surface of the first earphone body is symmetrical with respect to the symmetry plane.

The outer surface of the second earphone body is symmetrical with respect to the symmetry plane.

The outer surface of the connecting arm is symmetrical with respect to the symmetry plane.

It may be understood that the outer surfaces of the first earphone body, the flexible connecting arm, and the second earphone body are completely symmetrical with respect to the symmetry plane. Therefore, after the left ear earphone is originally set to be flipped, the left ear earphone can be worn on the right ear. Therefore, when wearing the earphone provided in this application, the user does not need to distinguish between the left ear and the right ear in terms of appearance.

In a possible implementation, the second earphone body further includes an antenna module, and the antenna module includes a main unit and a parasitic unit. The main unit and the parasitic unit are disposed inside the housing of the second earphone body. An outer surface of the housing of the second earphone is symmetrical with respect to the symmetry plane, and the main unit and the parasitic unit are symmetrical with respect to the symmetry plane.

It may be understood that when the user wears the earphone on the left ear, in a working process of the antenna module, when the main unit of the antenna structure is close to the skin of the user, the main unit is shielded to a large extent, and a signal is easily interfered with. The parasitic unit is located at a position far away from the user, the parasitic unit is shielded to a small extent, and the signal is not easily interfered with. When the user wears the earphone on the right ear, the parasitic unit is close to the skin of the user, and the main unit is located at a position far away from the user. In this way, regardless of whether the user wears the earphone on the left ear or the right ear, interference to the signal of the antenna module is similar, sensitivity of the earphone of playing sound or receiving the signal is also similar, and user experience is good.

In a possible implementation, the second earphone body includes a battery, a first electrode, and a second electrode, the first electrode and the second electrode are both embedded in the housing of the second earphone body, the first electrode and the second electrode are both electrically connected to the battery, and the first electrode, the second electrode, the first sound pickup hole, and the second sound pickup hole are spaced from each other. The outer surface of the housing of the second earphone is symmetrical with respect to the symmetry plane, one end of the first electrode and one end of the second electrode are exposed relative to the outer surface of the housing of the second earphone body, and the first electrode and the second electrode are symmetrical with respect to the symmetry plane.

It may be understood that one end of the first electrode and one end of the second electrode are exposed relative to the outer surface of the housing of the second earphone body, and the first electrode and the second electrode are symmetrical with respect to the symmetry plane. Regardless of whether the user wears the earphone on the left ear or the right ear, the first electrode and the second electrode on the housing of the second earphone body have a same appearance. User experience is good when the user wears the earphone.

In a possible implementation, the first earphone body includes the housing and a speaker, the speaker is fastened to an inner surface of the housing of the first earphone body, the speaker and the inner surface of the housing of the first earphone body enclose a first sub-cavity, the speaker and the inner surface of the housing of the first earphone body enclose a second sub-cavity, and a sound-emitting surface of the speaker faces the first sub-cavity. The outer surface of the first earphone body is symmetrical with respect to the symmetry plane, the housing of the first earphone body is has two (first and second) vent holes, the vent holes connect the second sub-cavity to the outside of the first earphone body, and the two vent holes are spaced from each other and are symmetrical with respect to the symmetry plane.

It can be understood that, in comparison with a manner in which only one vent hole is disposed, regardless of whether the user wears the earphone on the left ear or the right ear, the two vent holes are symmetrical with respect to the symmetry plane. One of the two vent holes always faces the ground, and the other vent hole faces a side away from the ground, to ensure vent effect. When the user wears the earphone, there is no need to distinguish between the left ear and the right ear. In addition, when sweat blocks one of the vent holes, the other vent hole can work to balance air pressure in the second sub-cavity.

In a possible implementation, the first earphone body includes the housing and a vibrate pickup sensor, and the vibrate pickup sensor is disposed inside the housing of the first earphone body.

It can be understood that the bone vibration sensor may be configured to pick up vibration generated when the user speaks, to facilitate call noise reduction.

In a possible implementation, in a length direction of the connecting arm, the connecting arm has a first end part and a second end part that are spaced from each other, the first end part is connected to the first earphone body, and the second end part is connected to the second earphone body. A central axis direction of the first end part and a central axis direction of second end part are arranged at an angle, with the angle ranging from 11.4° to 26°.

It can be understood that, in comparison with a solution in which the central axis direction of the first end part of the connecting arm 300 and the central axis direction of the second end part of the connecting arm are disposed in parallel, the first end part and the second end part of the connecting arm are disposed at the angle ranging from 11.4° to 26°. When the user wears an earphone 0, relative positions of the first earphone body and the second earphone body can better fit an ear inclination angle and a contour curve of the user. This effectively reduces a pressing feeling of the first earphone body and the second earphone body of the earphone 0 on the earphone, and improves user experience.

In a possible implementation, the connecting arm includes a pipe body and a cable bundle. The pipe body has a first channel, the first channel is disposed in a length direction of the pipe body, openings of the first channel are respectively located on a first end surface and a second end surface of the pipe body, the cable bundle is located in the first channel, one end of the cable bundle is exposed on the first end surface of the pipe body and is configured to electrically connect to the first earphone body, and the other end of the cable bundle is exposed on the second end surface of the pipe body and is configured to electrically connect to the second earphone body. There is a gap between the cable bundle and a wall surface of the first channel.

It may be understood that when the connecting arm is bent, a deformation degree of the cable bundle may be less than a deformation degree of the pipe body. In other words, when the connecting arm is bent, a stretching amount of the cable bundle is less than a stretching amount of the pipe body. In this way, the cable bundle is not easily broken, and has a long service life.

In a possible implementation, the cable bundle includes a first signal line, a second signal line, a first packaging member, and a second packaging member, and the first signal line is a current transmission channel of a power supply. The second signal line is a signal transmission channel of the speaker, a second mounting channel is disposed on second packaging member in a length direction of the second packaging member, the second signal line is assembled in the second mounting channel, and the second packaging member and second signal line form a sub-cable bundle. A first mounting channel is disposed on the first packaging member in a length direction of the first packaging member, and the sub-cable bundle and the first signal line are jointly assembled in the second mounting channel.

It may be understood that a signal of the speaker is easily affected by another signal, and has a high crosstalk requirement. The second signal line is independently assembled and packaged by using the second packaging member 343 to form the sub-cable bundle. Then, the second signal line and the first signal line are assembled and packaged by using the first packaging member. The signal of the speaker is not easily interfered by a line of another signal, and sound effect of the earphone is good.

In a possible implementation, a length of the housing of the second earphone body in a second direction is less than a length in the first direction, and the second direction is a direction in which an end part (namely, the second end part) of the connecting arm connected to the second earphone body points to the center of the outer surface of the second earphone body. A length of the housing of the second earphone body in a third direction is less than the length in the first direction, the third direction is perpendicular to the first direction, and the third direction is perpendicular to the second direction.

It may be understood that the housing of the second earphone body is ellipsoidal as a whole. When the user wears the earphone, the first direction is approximately the same as a length direction of the ear. In comparison with a technical solution in which the first direction is perpendicular to the length direction of the ear, in this solution, when the user wears the earphone, the second earphone body can better fit an arc surface of an auricle of the user, so that wearing comfort of the user can be improved.

In a possible implementation, there is a third gap S1 between the connecting arm and the first earphone body. There is a fourth gap S2 between the connecting arm and the second earphone body. The third gap S1 may be greater than the fourth gap S2.

It may be understood that in a process of assembling the connecting arm, the first earphone body, and the second earphone body, due to an assembly tolerance, when the included angle between the central axis direction of the first end of the pipe body and the central axis direction of the second end of the pipe body does not reach a preset ideal angle, the third gap S1 between the first connecting member and the first earphone body may be used for fine adjustment, to adjust a relative position between the first earphone body and the second earphone body.

According to a second aspect, this application provides an audio apparatus. The audio apparatus includes an earphone case and an earphone, and the earphone is disposed in the earphone case.

### BRIEF DESCRIPTION OF DRAWINGS

To describe technical solutions in embodiments of this application, the following describes accompanying drawings used in embodiments of this disclosure.

FIG. 1 is a diagram of a structure of an implementation of an earphone according to this disclosure;

FIG. 2 is an exploded diagram of an implementation of the earphone shown in FIG. 1;

FIG. 3 is a status diagram of an implementation in which a user uses an earphone provided in this disclosure;

FIG. 4 is a diagram of a structure of a second earphone body shown in FIG. 2 from a different perspective;

FIG. 5 is an exploded diagram of an implementation of the second earphone body shown in FIG. 4;

FIG. 6 is a partial sectional diagram of an implementation of the second earphone body shown in FIG. 4 at a section line A-A;

FIG. 7 is a diagram of a structure of an implementation of a third housing shown in FIG. 5;

FIG. 8 is an assembly diagram of an implementation of an antenna module and a third housing shown in FIG. 5;

FIG. 9 is an exploded diagram of an implementation of the antenna module shown in FIG. 8;

FIG. 10 is an assembly diagram of a partial structure of the second earphone body shown in FIG. 5;

FIG. 11 is a sectional diagram of an implementation of the structure shown in FIG. 10 at a section line B-B;

FIG. 12 is an assembly diagram of an implementation of a first feedforward microphone, a second feedforward microphone, a first bracket, a second bracket, and a second circuit board shown in FIG. 5;

FIG. 13 is a partial sectional diagram of an implementation of a structure shown in FIG. 12 at a section line C-C;

FIG. 14 is a partial sectional diagram of an implementation of the structure shown in FIG. 10 at a section line D-D;

FIG. 15 is a diagram of a structure of an implementation of a mainboard bracket shown in FIG. 5;

FIG. 16 is an assembly diagram of an implementation of a circuit board and a mainboard bracket shown in FIG. 5;

FIG. 17 is a schematic view of the structure shown in FIG. 16 from a different perspective;

FIG. 18 is an assembly diagram of a partial structure of the second earphone body shown in FIG. 5;

FIG. 19 is a sectional diagram of an implementation of the second earphone body shown in FIG. 18 at a section line E-E;

FIG. 20 is a sectional diagram of an implementation of the second earphone body shown in FIG. 18 at a section line F-F;

FIG. 21 is an assembly diagram of a partial structure of the second earphone body shown in FIG. 5;

FIG. 22 is a sectional diagram of an implementation of the structure shown in FIG. 21 at a section line G-G;

FIG. 23 is a diagram of a structure of the earphone shown in FIG. 1 from a different perspective;

FIG. 24 is a diagram of a structure of an implementation of a first earphone body shown in FIG. 1;

FIG. 25 is an exploded diagram of a partial structure of the first earphone body shown in FIG. 24;

FIG. 26 is a partial sectional diagram of an implementation of the first earphone body shown in FIG. 24 at a section line H-H;

FIG. 27 is a partial sectional diagram of an implementation of the first earphone body shown in FIG. 24 at a section line I-I;

FIG. 28 is a diagram of a structure of an implementation of a cable bundle bracket shown in FIG. 25;

FIG. 29 is a diagram of a structure of a cable bundle bracket shown in FIG. 28 from a different perspective;

FIG. 30 is a partial sectional diagram of an implementation of the first earphone body shown in FIG. 24 at a section line H-H;

FIG. 31 is an assembly diagram of an implementation of a vibrate pickup sensor and a cable bundle bracket shown in FIG. 25;

FIG. 32 is a partial sectional diagram of an implementation of the first earphone body shown in FIG. 24 at a section line I-I;

FIG. 33 is a diagram of a structure of an implementation of a first circuit board shown in FIG. 25;

FIG. 34 is a diagram of a partial structure of an implementation of the first earphone body shown in FIG. 24;

FIG. 35 is a schematic view of the structure shown in FIG. 34 from a different perspective;

FIG. 36 is an enlarged diagram of an implementation of a structure shown in FIG. 27 at a position J;

FIG. 37 is a sectional diagram of an implementation of the earphone shown in FIG. 1 on an O-O plane;

FIG. 38 is a sectional diagram of an implementation of a connecting arm shown in FIG. 1 at a section line K-K;

FIG. 39 is a sectional diagram of an implementation of the connecting arm shown in FIG. 38 at a section line L-L;

FIG. 40 is a sectional diagram of an implementation of the connecting arm shown in FIG. 38 at a section line M-M;

FIG. 41 is an enlarged diagram of an implementation of a structure shown in FIG. 37 at a position N;

FIG. 42 is a sectional diagram of an implementation of a cable bundle shown in FIG. 38 at a section line P-P;

FIG. 43 is an assembly diagram of an implementation of a cable bundle, a first circuit board, and a second circuit board;

FIG. 44 is an assembly diagram of an implementation of a cable bundle, a first circuit board, and a cable bundle bracket; and

FIG. 45 is a diagram of a structure of an implementation of an audio apparatus according to this disclosure.

### DESCRIPTION OF EMBODIMENTS

The following describes embodiments of this application with reference to the accompanying drawings in embodiments of this disclosure.

In the descriptions of embodiments of this disclosure, it should be noted that terms “dispose” and “connection” should be understood in a broad sense unless there is a clear stipulation and limitation. For example, “connection” may be a detachable connection, a non-detachable connection, a direct connection, or an indirect connection through an intermediate medium. “Fastening” means that two parts are connected to each other and a relative position relationship remains unchanged after the two parts are connected. It should be understood that when component A is fastened to component C through component B, a relative position relationship change caused by deformation of component A, component B, and component C is allowed. Integrating two components into an integral structure by using an integral molding process means that, in a process of forming one of the two components, the component is connected to the other component, and the two components are connected without secondary processing (for example, adhesive bonding, welding, buckle connection, or screw connection).

Orientation terms mentioned in embodiments of this disclosure, for example, “upper”, “lower”, and “side”, are merely reference directions of the accompanying drawings. Therefore, the orientation terms are used to better and more clearly describe and understand the embodiments of this application, instead of indicating or implying that the apparatus or element to which the orientation terms are directed needs to have a specific orientation, or be constructed and operated in a specific orientation. Therefore, the orientation terms cannot be understood as a limitation on embodiments of this disclosure.

The term “a plurality of” means at least two. The term “above” includes a present number. The term “and/or” describes an association relationship between associated objects and represents that three relationships may exist. For example, A and/or B may represent the following three cases: Only A exists, both A and B exist, and only B exists. Terms such as “first” and “second” are used only for description purposes, and cannot be understood as an indication or implication of relative importance or an implicit indication of a quantity of indicated technical features. Therefore, a feature limited by “first” or “second” may explicitly or implicitly include one or more features.

This disclosure provides an earphone 1000 and a pair of earphones. The earphone 1000 is a clip-on wireless earphone (True Wireless Stereo, TWS) that can be clipped on an ear. The clip-on wireless earphone can alleviate wearer's discomfort and improve wearing comfort. The pair of earphones includes two earphones 1000: a first earphone and a second earphone. The first earphone and the second earphone are respectively worn on the left ear and the right ear of a user. The first earphone and the second earphone are not distinguished between left and right ears. In other words, the first earphone may be worn on the left ear or the right ear, and the second earphone may be worn on the left ear or the right ear. In this way, use portability performance of the earphone 1000 is improved.

In some implementations, the earphone 1000 may be an open earphone. In this way, the earphone does not need to be inserted into an ear canal of a user, so that ear canal allergy and damage can be reduced, and the user can perceive a change of an ambient environment at any time, thereby reducing an accident risk.

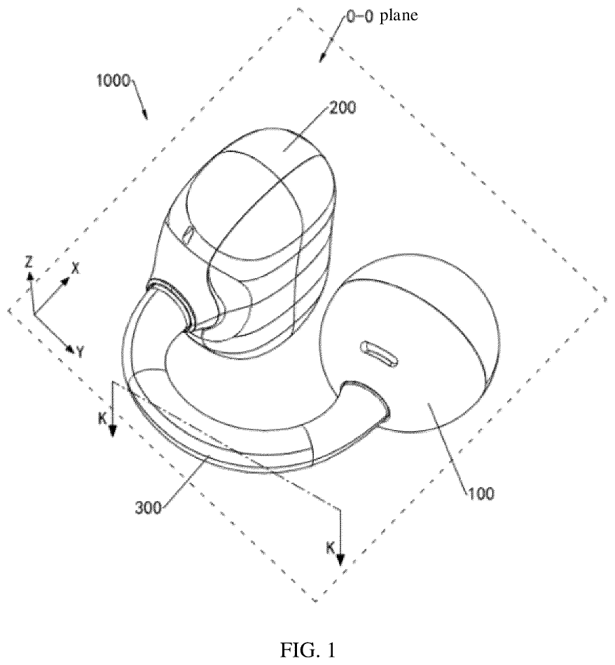

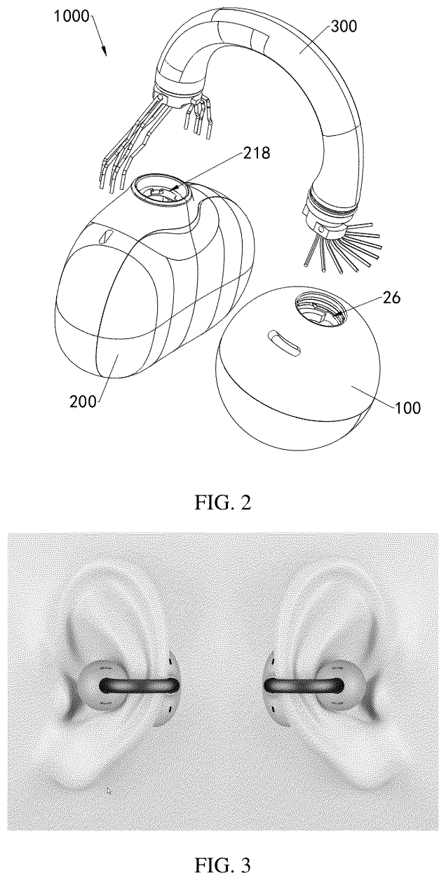

FIG. 1 is a diagram of a structure of an implementation of the earphone 1000 according to this application. FIG. 2 is an exploded diagram of an implementation of the earphone 1000 shown in FIG. 1.

As shown in FIG. 1 and FIG. 2, the earphone 1000 is approximately U-shaped, and includes a first earphone body 100, a second earphone body 200, and a connecting arm 300. The connecting arm 300 is approximately U-shaped, and is connected between the first earphone body 100 and the second earphone body 200. The first earphone body 100 is electrically connected to the second earphone body 200. For example, in a length direction of the connecting arm 300, the connecting arm 300 has a first end part and a second end part that are disposed opposite to each other, the first end part is connected to the first earphone body 100, and the second end part is connected to the second earphone body 200. In this way, the first earphone body 100 and the second earphone body 200 may be physically connected through the connecting arm 300. In addition, the first earphone body 100 and the second earphone body 200 may be electrically connected through the connecting arm 300. For example, the connecting arm 300 may include a cable bundle, one end of the cable bundle is electrically connected to the first earphone body 100, and the other end of the cable bundle may be electrically connected to the second earphone body 200.

For ease of description, a unique plane is determined by a geometric center of an outer surface of the first earphone body 100, a geometric center of an outer surface of the second earphone body 200, and a geometric center of an outer surface of the connecting arm 300, and the plane is an O-O plane (indicated by a dashed line in FIG. 1). For ease of description, a direction perpendicular to the O-O plane is defined as a Z-axis, a direction in which an end part of the connecting arm 300 connected to the second earphone body 200 points to a center of the second earphone body 200 is defined as an X-axis direction, and a direction perpendicular to both the X-axis and the Z-axis is defined as a Y-axis.

In some implementations, the outer surface of the first earphone body 100 may be symmetrical with respect to a symmetry plane, the outer surface of the second earphone body 200 may be symmetrical with respect to a symmetry plane, and the outer surface of the connecting arm 300 may be symmetrical with respect to a symmetry plane. In this way, the entire earphone 1000 is symmetrical with respect to the symmetry plane.

FIG. 3 is a status diagram of an implementation in which a user uses the earphone 1000 provided in this application.

As shown in FIG. 3, the first earphone body 100 may be configured to emit sound. When the user uses the earphone, the first earphone body 100 may be clipped in a concha cavity of the user, and does not penetrate into an ear canal of the user. In other words, the earphone 1000 in this application is an open earphone. A tolerance degree of the concha cavity of a human body is far higher than that of the ear canal. Therefore, in comparison with an in-ear audio device, the earphone 1000 provided in this application can greatly improve wearing comfort.

The second earphone body 200 is located on a side that is outside an ear of the user and that is away from the first earphone body 100. The connecting arm 300 is buckled to an outer edge side of the ear of the user, and extends from the concha cavity to a back position of the ear. It may be understood that the connecting arm 300, the first earphone body 100, and the second earphone body 200 together clamp an auricle of the user, so that the earphone 1000 is worn on the ear.

In some implementations, the connecting arm 300 may have a deformation capability, and may be configured to adjust a distance between the first earphone body 100 and the second earphone body 200, so that the distance between the first earphone body 100 and the second earphone body 200 is adjusted from an initial distance to an adjusted distance. The initial distance is a distance between the first earphone body 100 and the second earphone body 200 when the earphone 1000 is not worn on the ear of the user. The adjusted distance is a distance obtained by increasing or decreasing the initial distance. It should be noted that, both the initial distance and the adjusted distance are the distance between the first earphone body 100 and the second earphone body 200, that is, a distance between surfaces that face each other and that are of the first earphone body 100 and the second earphone body 200, that is, a distance between surfaces that are of two earphones 1000 and that first contact with the ears.

It may be understood that the earphone 1000 with the connecting arm 300 having the deformation capability may be adapted to users with different ear thicknesses, to provide appropriate clamping force for the users, and avoid affecting wearing experience due to excessively tight or loose clamping force. In addition, when wearing and taking off the earphone 1000 provided in this application, the user may use the connecting arm 300 to increase the distance between the first earphone body 100 and the second earphone body 200, to ensure that the earphone 1000 is smoothly worn and taken off. This avoids deforming the ear due to pressure, and improves user experience of wearing and taking off the earphone 1000.

When the user uses the earphone, the first earphone body 100 may be configured to emit the sound. For example, the first earphone body 100 may include a speaker, and emit the sound through the speaker. The first earphone body 100 may be clipped in the concha cavity of the user, and the second earphone body 200 is located on a side that is outside an ear of the user and that is away from the first earphone body 100. The second earphone body 200 may be configured to pick up external noise of the second earphone body 200, and is used in an active noise cancelling (Active Noise Cancelling, ANC) design system of the earphone 1000. Active noise cancelling is a method of identifying an unwanted sound source as noise, and eliminating original noise by generating an “anti-noise” signal, to eliminate noise in real time. When the user uses the earphone 1000, the user hears low noise in the sound emitted by the earphone 1000. Therefore, user experience is better. The following describes an implementation of the second earphone body 200 in detail with reference to the accompanying drawings.

In some implementations, the outer surface of the first earphone body 100 is symmetrical with respect to a first symmetry plane. The outer surface of the second earphone body 200 is symmetrical with respect to a second symmetry plane. The outer surface of the connecting arm 300 is symmetrical with respect to a third symmetry plane. The first symmetry plane, the second symmetry plane, and the third symmetry plane are coplanar. For example, any one of the first symmetry plane, the second symmetry plane, and the third symmetry plane may be coplanar with the symmetry plane (namely, an O-O plane). In this way, an overall appearance of the earphone 1000 is a symmetrical structure, and the user does not need to distinguish between left and right ears when using the earphones 1000.

In another implementation, due to an assembly tolerance, any two of the first symmetry plane, the second symmetry plane, and the third symmetry plane may have an included angle, and the included angle is less than or equal to 1°. For example, the included angle between any two of the first symmetry plane, the second symmetry plane, and the third symmetry plane may be 0.2°, 0.5°, 0.9°, 1°, or the like. For example, the included angle between the first symmetry plane and the second symmetry plane may be less than 1°, the included angle between the first symmetry plane and the third symmetry plane may be less than 1°, or the included angle between the second symmetry plane and the third symmetry plane may be less than 1°.

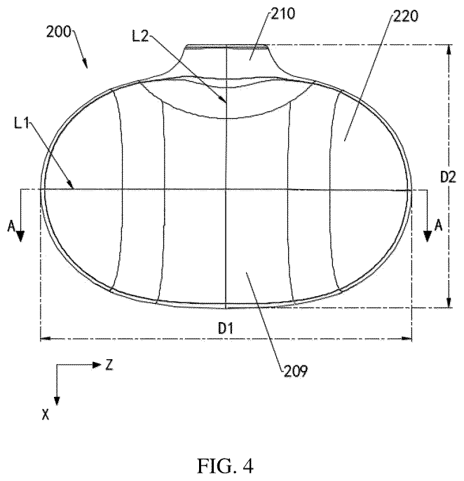

FIG. 4 is a diagram of a structure of the second earphone body 200 shown in FIG. 2 from a different perspective.

As shown in FIG. 2 and FIG. 4, a length D1 of a housing 209 of the second earphone body in a first direction is greater than a length D2 of the housing 209 of the second earphone body in a second direction. The second direction is a direction in which an end part (namely, a second end part) of the connecting arm 300 connected to the second earphone body 200 points to the center of the outer surface of the second earphone body 200. The second direction is different from the first direction. FIG. 4 shows that the first direction is a Z-axis direction, and the second direction is an X-axis direction. In another implementation, the first direction may alternatively be any direction in an X-Z plane, for example, may be a direction that forms an included angle with the Z axis. Alternatively, the second direction may be any direction in the X-Z plane, for example, may be a direction that forms an included angle with the X axis.

For example, the second earphone body 200 includes a long axis L1. The long axis L1 is a connection line between two farthest endpoints of the housing 209 of the second earphone body 200 in the first direction. There may be a plurality of connection lines on the housing 209 of the second earphone body 200 in the first direction, and the long axis L1 is the longest one in the connection lines. A length of the long axis L1 is D1.

In some implementations, the second symmetry plane is perpendicular to the first direction (namely, the Z-axis direction). In this case, the second symmetry plane is an X-Y plane.

In some implementations, the second earphone body 200 may include a short axis L2. The short axis L2 is a length between two farthest endpoints of the second earphone body 200 in the second direction. There may be a plurality of connection lines on the housing 209 of the second earphone body 200 in the second direction, and the short axis L2 is the longest one in connection lines.

For example, a length D2 of the short axis L2 is in a range of 11.44 millimeters (millimeter, mm) to 13.44 mm. For example, the length D2 of the short axis L2 may be 11.44 mm, 12.44 mm, or 13.44 mm.

In some implementations, a length of the housing 209 of the second earphone body 200 in the second direction is less than a length of the housing 209 of the second earphone body 200 in the first direction. A length of the housing 209 of the second earphone body 200 in a third direction is less than the length of the housing 209 of the second earphone body 200 in the first direction, and the third direction and the second direction are different from the first direction. FIG. 2 shows that the third direction is a Y-axis direction. In another implementation, the third direction may alternatively be any direction in the X-Y plane, for example, may be a direction that forms an included angle with the Y axis. In this way, the second earphone body 200 may be approximately in an ellipsoid shape. When the user wears the earphone 1000, a long direction of the ellipsoid shape is approximately the same as a length direction of the ear.

In some implementations, a shape of the housing 209 of the second earphone body 200 may be in a “broad bean” shape. It may be understood that the second earphone body 200 is designed in the broad bean shape, and fits an arc surface of an auricle of the user during wearing, so that wearing comfort of the user can be improved. When the user wears the earphone 1000, the first direction is approximately the same as the length direction of the ear.

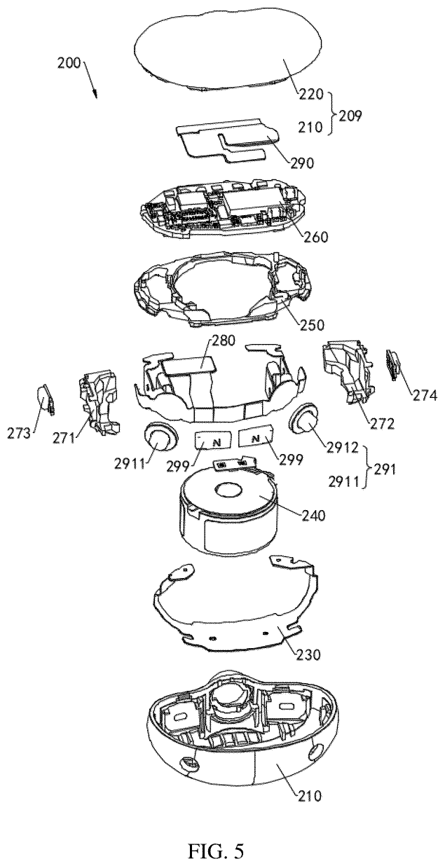

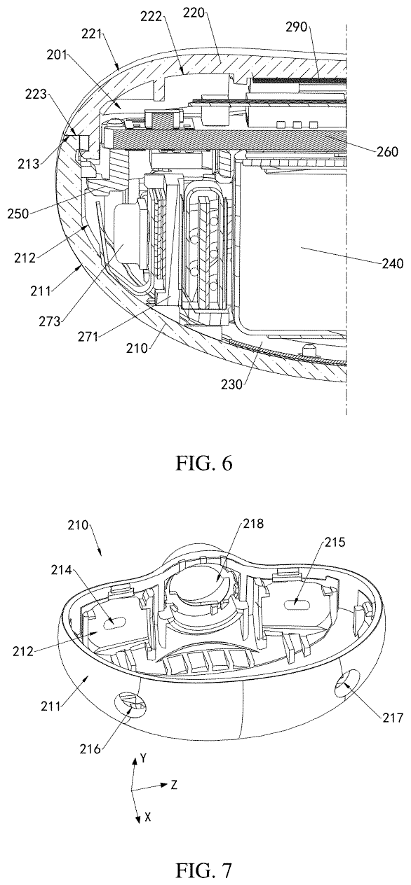

FIG. 5 is an exploded diagram of an implementation of the second earphone body 200 shown in FIG. 4. FIG. 6 is a partial sectional diagram of an implementation of the second earphone body 200 shown in FIG. 4 at a section line A-A.

As shown in FIG. 5 and FIG. 6, the second earphone body 200 may include the housing 209, an antenna module 230, a battery 240, a mainboard bracket 250, a mainboard 260, a first bracket 271, a second bracket 272, a first feedforward microphone 273, a second feedforward microphone 274, a second circuit board 280, a second capacitive sensor 290, and a charging terminal 291. The antenna module 230, the battery 240, the mainboard bracket 250, the mainboard 260, the first bracket 271, the second bracket 272, the first feedforward microphone 273, the second feedforward microphone 274, the second circuit board 280, and the second capacitive sensor 290 may all be disposed inside the housing 209 of the second earphone body 200.

For example, the housing 209 of the second earphone body 200 may include a third housing 210 and a fourth housing 220. The third housing 210 is connected to the fourth housing 220, to enclose a second space 201. The antenna module 230, the battery 240, the mainboard bracket 250, the mainboard 260, the first bracket 271, the second bracket 272, the first feedforward microphone 273, the second feedforward microphone 274, the second circuit board 280, and the second capacitive sensor 290 may all be disposed in the second space 201.

As shown in FIG. 6, the third housing 210 may have an outer surface 211, an inner surface 212, and a third end surface 213. The outer surface 211 and the inner surface 212 are disposed opposite to each other, and the inner surface 212 faces the second space 201. The third end surface 213 is connected between the outer surface 211 and the inner surface 212. The fourth housing 220 may have an outer surface 221, an inner surface 222, and a fourth end surface 223. The outer surface 221 and the inner surface 222 are disposed opposite to each other, and the inner surface 222 faces the second space 201. The fourth end surface 223 is connected between the outer surface 221 and the inner surface 222.

When the third housing 210 is connected to the fourth housing 220, the third end surface 213 of the third housing 210 is connected to the fourth end surface 223 of the fourth housing 220. The outer surface 211 of the third housing 210 and the outer surface 221 of the fourth housing 220 form the outer surface of the second earphone body 200. The inner surface 212 of the third housing 210 and the inner surface 222 of the fourth housing 220 form an inner surface of the second earphone body 200. The inner surface 212 of the third housing 210 and the inner surface 222 of the fourth housing 220 enclose the second space 201.

In some implementations, the third housing 210 may be symmetrical with respect to the second symmetry plane. The fourth housing 220 may also be symmetrical with respect to the second symmetry plane. In this way, the outer surface of the second earphone body 200 formed by the outer surface 211 of the third housing 210 and the outer surface 221 of the fourth housing 220 may also be symmetrical with respect to the second symmetry plane.

FIG. 7 is a diagram of a structure of an implementation of the third housing 210 shown in FIG. 5.

As shown in FIG. 7, the third housing 210 has a first sound pickup hole 214 and a second sound pickup hole 215 that are spaced from each other. The first sound pickup hole 214 communicates the outer surface 211 and the inner surface 212 of the third housing 210. The second sound pickup hole 215 may communicate the outer surface 211 and the inner surface 212 of the third housing 210.

In some implementations, the first sound pickup hole 214 and the second sound pickup hole 215 may be spaced from each other in the first direction. In some implementations, the first sound pickup hole 214 and the second sound pickup hole 215 may be symmetrical with respect to the second symmetry plane.

The third housing 210 has a first charging hole 216 and a second charging hole 217 that are spaced from each other. The first charging hole 216, the second charging hole 217, the first sound pickup hole 214, and the second sound pickup hole 215 are spaced from each other. The first charging hole 216 may communicate with the outer surface 211 and the inner surface 212 of the third housing 210. The second charging hole 217 may communicate with the outer surface 211 and the inner surface 212 of the third housing 210.

In some implementations, the first charging hole 216 and the second charging hole 217 may be spaced from each other in the first direction.

In some implementations, the first charging hole 216 and the second charging hole 217 may be symmetrical with respect to the symmetry plane (namely, the O-O plane).

The third housing 210 may further have a first connecting hole 218. The first connecting hole 218 is spaced from the first sound pickup hole 214, the second sound pickup hole 215, the first charging hole 216, and the second charging hole 217. The first connecting hole 218 is connected to the outer surface 211 and the inner surface 212 of the third housing 210.

In some implementations, the first sound pickup hole 214 and the second sound pickup hole 215 may be spaced from each other in the first direction, and are located on two sides of the first connecting hole 218. FIG. 8 is an assembly diagram of an implementation of the antenna module 230 and the third housing 210 shown in FIG. 5.

As shown in FIG. 8, the antenna module 230 may be fastened to the inner surface 212 of the third housing 210. For example, the antenna module 230 may be fastened to the inner surface 212 of the third housing 210 through adhesive bonding, welding, or the like.

In some implementations, the inner surface 212 of the third housing 210 may have a first positioning pillar 2121. The first positioning pillar 2121 may be formed by protruding the inner surface 212. In addition, the antenna module 230 may correspondingly have a positioning hole 233. When the antenna module 230 is mounted to the third housing 210, the first positioning pillar 2121 is at least partially located in the positioning hole 233. It may be understood that the first positioning pillar 2121 and the positioning hole 233 are disposed, so that quick positioning can be facilitated in an assembly process of the antenna module 230, and displacement of the antenna module 230 can be further prevented in a subsequent assembly process.

In some implementations, the antenna module 230 may be symmetrical with respect to the O-O symmetry plane.

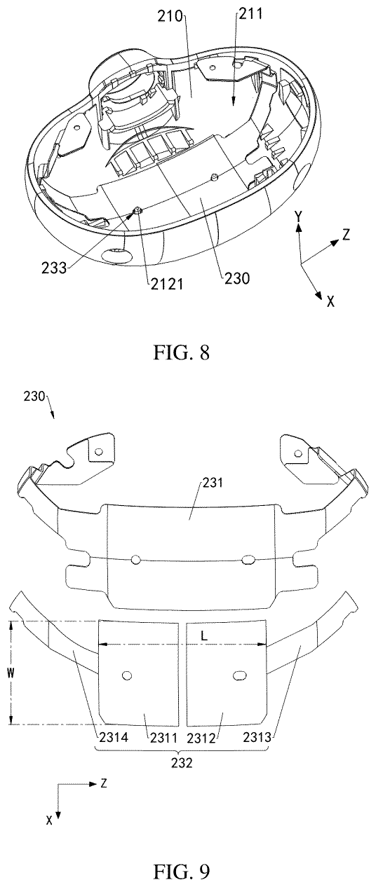

FIG. 9 is an exploded diagram of an implementation of the antenna module 230 shown in FIG. 8.

As shown in FIG. 9, the antenna module 230 may include a packaging structure 231 and an antenna structure 232. The antenna structure 232 is embedded in the packaging structure 231. The packaging structure 231 is configured to protect and insulate the antenna structure 232. The antenna structure 232 may be configured to receive and send an antenna signal.

In some implementations, the antenna structure 232 may be symmetrical with respect to the O-O symmetry plane. In this way, regardless of whether the user wears the earphone 1000 on the left ear or the right ear, interference to a signal of the antenna module 230 differs slightly, sensitivity of the earphone 1000 of playing sound or receiving the signal is also similar, and user experience is good.

In some implementations, the antenna module 230 may be made of a monopole antenna with a parasitic unit. For example, the antenna structure 232 includes a main unit 2311, a parasitic unit 2312, a grounding line 2313, and a feeding line 2314. The main unit 2311 and the parasitic unit 2312 are spaced and insulated from each other. One end of the feeding line 2314 is connected to the main unit 2311, and the other end is connected to the mainboard 250 (not shown in the figure). The feeding line 2314 is configured to supply power to the main unit 2311. One end of the grounding line 2313 is connected to the parasitic unit 2312, and the other end is connected to the mainboard 250 (not shown in the figure). The grounding line 2313 is configured to ground the parasitic unit 2312. The main unit 2311 is the monopole antenna. The parasitic unit 2312 is used as the parasitic unit. In a working process of the antenna module 230, the mainboard 250 (not shown in the figure) may supply power to the main unit 2311 through the feeding line 2314, to excite the main unit 2311 to work. After the main unit 2311 is fed, and the parasitic unit 2312 is excited through coupling with the main unit 2311. A capacitive coupling excited parasitic mode may be formed between the main unit 2311 and the parasitic unit 2312. In this way, the parasitic unit 2312 may also have a function of the antenna module 230.

In some implementations, the main unit 2311 and the parasitic unit 2312 may be symmetrical with respect to the O-O symmetry plane. It may be understood that, in a working process of the antenna module 230, when the main unit 2311 of the antenna structure 232 is close to skin of the user, the main unit 2311 is shielded to a large extent, and a signal is easily interfered; and the parasitic unit 2312 is located at a position far away from the user, the parasitic unit 2312 is shielded to a small extent, and the signal is not easily interfered. On the contrary, when the parasitic unit 2312 is close to the skin of the user, the main unit 2311 is located at a position far away from the user. In this way, regardless of whether the user wears the earphone 1000 on the left ear or the right ear, interference to the signal of the antenna module 230 is similar, sensitivity of the earphone 1000 of playing sound or receiving the signal is also similar, and user experience is good.

In some implementations, a distance between the main unit 2311 and the parasitic unit 2312 in the Z-axis direction may be 0.5 mm.

In some implementations, a length L of the antenna module 230 in the Z axis direction may be 13.8 mm. In the X axis direction, a width W of the antenna module 230 may be 5.9 mm.

In some implementations, the antenna module 230 may be flexible printed circuit (Flexible Printed Circuit, FPC) antenna. It may be understood that, in comparison with another form of the antenna module 230, the FPC antenna has a small volume, is flexible, and has high flexibility during deployment.

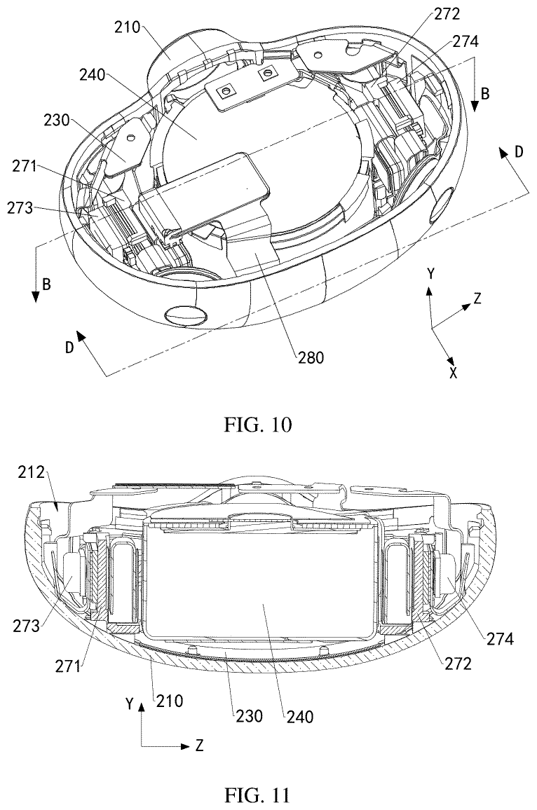

FIG. 10 is an assembly diagram of a partial structure of the second earphone body 200 shown in FIG. 5. FIG. 11 is a sectional diagram of an implementation of a structure shown in FIG. 10 at a section line B-B.

As shown in FIG. 10 and FIG. 11, the battery 240 may be disposed on a side that is of the antenna module 230 and that is away from the third housing 210. The battery 240 may be fastened to the inner surface 212 of the third housing 210. For example, the battery 240 may be fastened to the inner surface 212 of the third housing 210 through adhesive bonding.

In some implementations, in the Y-axis direction, the battery 240 and the antenna module 230 are disposed opposite to and spaced from each other. For example, in the Y-axis direction, a distance between the battery 240 and the antenna module 230 may be greater than or equal to 0.2 mm. For example, the distance between the battery 240 and the antenna module 230 may be greater than or equal to 0.23 mm.

In the first direction (namely, the Z-axis direction), the first bracket 271 and the second bracket 272 are spaced on two sides of the battery 240. The first bracket 271 and the second bracket 272 are spaced from the antenna module 230. For example, the first bracket 271 and the second bracket 272 may be fastened to the third housing 210. For example, the first bracket 271 and the second bracket 272 may be fastened to the third housing 210 through adhesive bonding. The first feedforward microphone 273 is fastened to the first bracket 271, and is spaced from the battery 240 and the antenna module 230. The second feedforward microphone 274 is fastened to the second bracket 272, and is spaced from the battery 240 and the antenna module 230. The first bracket 271 may be configured to bear the first feedforward microphone 273. The second bracket 272 may be configured to bear the second feedforward microphone 274. The first feedforward microphone 273 and the second feedforward microphone 274 are configured to perform active noise reduction, pick up ambient sound (namely, extracranial noise) near the second earphone body 200, and output anti-phase sound to cancel the ambient sound. For example, the first feedforward microphone 273 may be fastened to a side that is of the first bracket 271 and that is away from the battery 240. The second feedforward microphone 274 may be fastened to a side that is of the second bracket 272 and that is away from the battery 240. In this case, the first feedforward microphone 273 and the second feedforward microphone 274 are spaced from each other in the Z-axis direction.

In some implementations, the first bracket 271 and the second bracket 272 may be symmetrical with respect to the O-O plane.

In some implementations, the first feedforward microphone 273 and the second feedforward microphone 274 may be symmetrical with respect to the O-O plane.

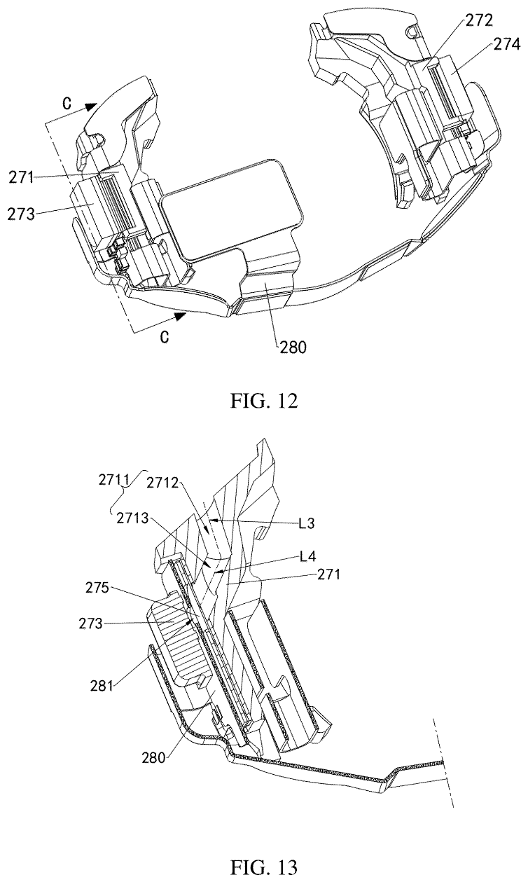

FIG. 12 is an assembly diagram of an implementation of the first feedforward microphone 273, the second feedforward microphone 274, the first bracket 271, the second bracket 272, and the second circuit board 280 shown in FIG. 5. FIG. 13 is a partial sectional diagram of an implementation of a structure shown in FIG. 12 at a section line C-C.

As shown in FIG. 12 and FIG. 13, the first feedforward microphone 273 and the second feedforward microphone 274 are connected to the second circuit board 280, and are electrically connected to the second circuit board 280. The first bracket 271 and the second bracket 272 are connected to the second circuit board 280. For example, the second circuit board 280 is disposed between the first feedforward microphone 273 and the first bracket 271. The first bracket 271 may be further configured to bear a part of the second circuit board 280 that is connected between the first feedforward microphone 273 and the first bracket 271. The second circuit board 280 is disposed between the second feedforward microphone 274 and the second bracket 272. The second bracket 272 may be further configured to bear a part of the second circuit board 280 that is connected between the second feedforward microphone 274 and the second bracket 272.

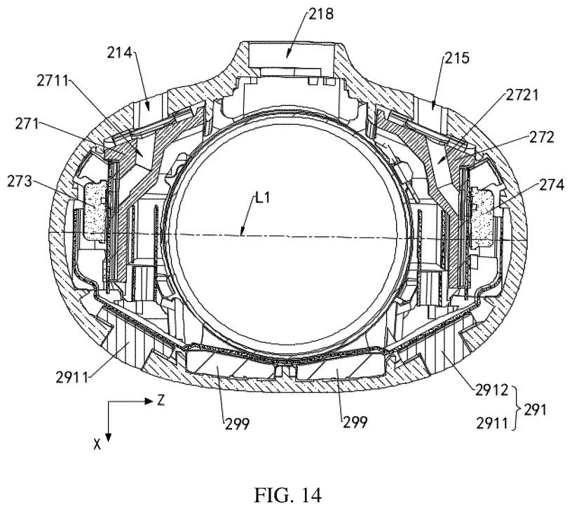

FIG. 14 is a partial sectional diagram of an implementation of a structure shown in FIG. 10 at a section line D-D.

As shown in FIG. 14, the second earphone body 200 may have a first pipe 2711, the first pipe 2711 is located inside the housing of the second earphone body 200, the first pipe 2711 communicates with the first sound pickup hole 214, and a sound pickup surface of the first feedforward microphone 273 is disposed opposite to the first pipe 2711. The second earphone body 200 may have a second pipe 2721, the second pipe 2721 is located inside the housing 209 of the second earphone body 200, the second pipe 2721 communicates with the second sound pickup hole 215, and a sound pickup surface of the second feedforward microphone 274 is disposed opposite to the second pipe 2721.

For example, the first bracket 271 may have the first pipe 2711. One end of the first pipe 2711 is disposed opposite to and communicates with the first sound pickup hole 214. The other end of the first pipe 2711 is disposed opposite to the sound pickup surface of the first feedforward microphone 273. In this way, external noise near the first sound pickup hole 214 of the second earphone body 200 may reach near the sound pickup surface of the first feedforward microphone 273 through the first sound pickup hole 214 and the first pipe 2711, and may be picked up by the first feedforward microphone 273. The second bracket 272 may also have the second pipe 2721. One end of the second pipe 2721 may be disposed opposite to and communicates with the second sound pickup hole 215. The other end of the second pipe 2721 may be disposed opposite to the sound pickup surface of the second feedforward microphone 274. In this way, external noise near the second sound pickup hole 215 of the second earphone body 200 may reach the sound pickup surface of the second feedforward microphone 274 through the second sound pickup hole 215 and the second pipe 2721, and may be picked up by the second feedforward microphone 274.

In another implementation, the first bracket 271 and the second bracket 272 may not be disposed on the second earphone body 200. In this case, the first pipe 2711 and the second pipe 2721 may be formed by the third housing 210.

In another implementation, the first bracket 271 and the second bracket 272 may not be disposed on the second earphone body 200. In this case, the sound pickup surface of the first feedforward microphone 273 is disposed opposite to the first sound pickup hole 214, and the sound pickup surface of the second feedforward microphone 274 is disposed opposite to the second sound pickup hole 215. The first feedforward microphone 273 picks up the external noise of the second earphone body 200 through the first sound pickup hole 214. The second feedforward microphone 274 picks up the external noise of the second earphone body 200 through the second sound pickup hole 215.

In some implementations, the first sound pickup hole 214 and the second sound pickup hole 215 may be spaced from each other in the first direction. The first sound pickup hole 214 and the second sound pickup hole 215 may be located on two sides of the second symmetry plane.

In some implementations, the first sound pickup hole 214 and the second sound pickup hole 215 may be symmetrical with respect to the O-O plane of the earphone 1000.

It may be understood that, in comparison with a solution in which only one of the first sound pickup hole 214 or the second sound pickup hole 215 is disposed, the first sound pickup hole 214 and the second sound pickup hole 215 are disposed to be symmetrical with respect to the O-O plane. Regardless of whether the user wears the earphone 1000 on the left ear or the right ear, one of the first sound pickup hole 214 and the second sound pickup hole 215 can be always located on a side away from the skin. In this way, it can be ensured that when the earphone 1000 works, regardless of whether the user distinguishes between the left ear and the right ear, one of the first feedforward microphone 273 or the second feedforward microphone 274 located on the side away from the skin of the user can better pick up ambient noise, and active noise reduction effect is better. In addition, regardless of whether the user wears the earphone 1000 on the left ear or the right ear, one of the first sound pickup hole 214 and the second sound pickup hole 215 can always face the ground, and the other faces a side away from the ground. When the sound pickup hole facing the side away from the ground is blocked by sweat, the other sound pickup hole can still work normally, to implement active noise reduction.

It should be noted that when the first sound pickup hole 214 and the second sound pickup hole 215 are symmetrical with respect to the O-O plane of the earphone 1000, a center of the first sound pickup hole 214 and a center of the second sound pickup hole may be symmetrical with respect to the O-O plane. A projection of the first sound pickup hole 214 on the O-O plane may partially overlap a projection of the second sound pickup hole 215 on the O-O plane.

In some implementations, a line connecting the center of the first sound pickup hole 214 and the center of the second sound pickup hole 215 may form an included angle with the O-O plane, and the included angle may be within a range of 88° to 90°.

In some implementations, the projection of the center of the first sound pickup hole on the symmetry plane is a first projection, the projection of the center of the second sound pickup hole on the symmetry plane is a third projection, and the first projection and the third projection overlap.

In some implementations, the projection of the first sound pickup hole 214 on the O-O plane and the projection of the second sound pickup hole 215 on the O-O plane may not completely overlap. A distance between the first projection and the third projection may be less than 0.5 mm.

The following describes two working manners in which the first feedforward microphone 273 and the second feedforward microphone 274 perform active noise reduction.
(1) In a working process in which the earphone 1000 performs active noise reduction, the first feedforward microphone 273 and the second feedforward microphone 274 may work at the same time, and pick up sound near the first sound pickup hole 214 and the second sound pickup hole 215 at the same time. After two pieces of data are fused by using an algorithm, active noise reduction is performed.
(2) When a low frequency signal of one of the first feedforward microphone 273 and the second feedforward microphone 274 is greater than a low frequency signal of the other, automatic selection may be performed by using a circuit switch, and a signal with a larger low frequency signal is selected as an input signal of the algorithm, to perform active noise reduction. For a signal with the larger low frequency signal, wind noise is small. This helps improve active noise reduction effect.

In some implementations, the first sound pickup hole 214 may be located on a side that is of the long axis L1 and that is close to the first connecting hole 218. Similarly, the second sound pickup hole 215 may be located on the side that is of the long axis L1 and that is close to the first connecting hole 218. For example, both the first sound pickup hole 214 and the second sound pickup hole 215 may be located on the side that is of the long axis L1 and that is close to the first connecting hole 218, and the first sound pickup hole 214 and the second sound pickup hole 215 may be symmetrical with respect to the O-O symmetry plane of the earphone 1000. As shown in FIG. 2, one end of the connecting arm 300 is extended into the second earphone body 200 through the first connecting hole 218.

It may be understood that, in comparison with a solution in which the long axis L1 passes through the first sound pickup hole 214 and the second sound pickup hole 215, the first sound pickup hole 214 and the second sound pickup hole 215 are disposed on one side of the long axis L1. When the user wears the earphone 1000, a risk of sweat dripping into the first sound pickup hole 214 or the second sound pickup hole 215 can be reduced, and the first sound pickup hole 214 or the second sound pickup hole 215 is prevented from being blocked by the sweat, thereby avoiding affecting sound pickup effect.

In some implementations, in the first direction, the projection of the center of the first sound pickup hole 214 on the symmetry plane is the first projection, a projection of a center of the first connecting hole 218 on the symmetry plane is a second projection, a distance between the first projection and the second projection is A1, and a distance between the second projection and the center of the outer surface of the second earphone body 200 is A2.

A relationship between A1 and A2 satisfies:

$$A 1 < \frac{1}{2} \times A 2 .$$

It may be understood that when the user wears the earphone 1000, the second earphone body 200 is located on a side that is outside an ear of the user and that is away from the first earphone body 100. The connecting arm 300 is buckled to the outer edge side of the ear of the user, and extends from the concha cavity to a back position of the ear. A distance between the position of the first sound pickup hole 214 and the connecting arm 300 may be less than a distance between the first sound pickup hole 214 and the skin of the user, and there is less blocking around the position of the first sound pickup hole. When the microphone in the second earphone body 200 picks up sound through the first sound pickup hole 214, there is less external blocking.

As shown in FIG. 13, when the second circuit board 280 is disposed between the first feedforward microphone 273 and the first bracket 271, the second circuit board 280 may have a first air hole 281, and the first air hole 281 is connected to the first pipe 2711. In this way, sound near the first sound pickup hole 214 may reach the vicinity of the sound pickup surface of the first feedforward microphone 273 through the first pipe 2711 and the first air hole 281, and be picked up by the first feedforward microphone 273.

In some implementations, when the second circuit board 280 is disposed between the second feedforward microphone 274 and the second bracket 272, the second circuit board 280 may have a second air hole (not shown in the figure). The second air hole is connected to the second pipe 2721.

In some implementations, the second earphone body 200 may further include a third water-resistant and breathable film 275. The third water-resistant and breathable film 275 may be disposed between the first bracket 271 and the first feedforward microphone 273. The third water-resistant and breathable film 275 may cover the first pipe 2711. For example, the third water-resistant and breathable film 275 may be disposed between the first bracket 271 and the second circuit board 280. It may be understood that, the third water-resistant and breathable film 275 is disposed, so that the third water-resistant and breathable film 275 can prevent external dust and water vapor from entering the second earphone body 200 through the first pipe 2711 without affecting sound pickup of the first feedforward microphone 273, thereby avoiding affecting working of an internal component of the second earphone body 200.

In some implementations, the second earphone body 200 may further include a fourth water-resistant and breathable film (not shown in the figure). The fourth water-resistant and breathable film may be fastened to the second bracket 272, and covers the second pipe 2721.

As shown in FIG. 13, the first pipe 2711 may be curved, that is, the first pipe 2711 may include a curved pipe. For example, the first pipe 2711 may include a first segment 2712 and a second segment 2713. The first segment 2712 is connected to the second segment 2713, and the first segment 2712 is connected to an end that is of the second segment 2713 and that is away from the first feedforward microphone 273. An included angle is formed between a central axis L3 (indicated by a dashed line in FIG. 13) of the first segment 2712 and a central axis L4 (indicated by a dashed line in FIG. 13) of the second segment 2713. The first pipe 2711 may be in an “L” shape or a “V” shape as a whole.

It may be understood that, in comparison with the first pipe 2711 that is a straight pipe as a whole, the first pipe 2711 that is curved as a whole may have wind noise prevention effect. When airflow near the first sound pickup hole 214 passes through the first pipe 2711, the curved pipe may buffer the airflow, and wind noise in sound picked up by the first feedforward microphone 273 is small. In another implementation, the first pipe 2711 may be in an “N” shape, an “S” shape, a “Z” shape, a “C” shape, or the like as a whole. It may be understood that a shape of the first pipe 2711 may be adjusted based on an actual situation, and the first pipe 2711 may include a plurality of curved pipes, or may include one curved pipe.

In some implementations, a diameter of the first pipe 2711 may be greater than 0.6 mm. For example, the diameter of the first pipe 2711 may be 0.6 mm, 0.7 mm, 0.9 mm, or 1.2 mm.

In some implementations, the second pipe 2721 may also be curved. For a manner of disposing the second pipe 2721, refer to the manner of disposing the first pipe 2711. Details are not described herein again.

In another implementation, the first sound pickup hole 214 and the second sound pickup hole 215 may alternatively be located on a side that is of the long axis L1 and that is away from the first connecting hole 218.

In another implementation, the third housing 210 may further have a third sound pickup hole (not shown in the figure) and a fourth sound pickup hole (not shown in the figure). The third sound pickup hole and the fourth sound pickup hole are located on the long axis L1 of the second earphone body 200, and are symmetrical with respect to the O-O symmetry plane of the earphone 1000. In this case, the first bracket 271 may further include a third pipe (not shown in the figure). One end of the third pipe is disposed opposite to the third sound pickup hole, and the other end is connected to the first pipe 2711. The second bracket 272 may further include a fourth pipe (not shown in the figure). One end of the fourth pipe is disposed opposite to the fourth sound pickup hole, and the other end is connected to the second pipe 2721. In this way, the first feedforward microphone 273 may pick up ambient sound near the first sound pickup hole 214 and the third sound pickup hole at the same time, and the second feedforward microphone 274 may pick up sound near the second sound pickup hole 215 and the fourth sound pickup hole at the same time. In another implementation, there may be one feedforward microphone. There may also be one sound pickup hole. The feedforward microphone may be disposed on the connecting arm 300, and the sound pickup hole may also be disposed on the connecting arm 300. In this way, when the earphone 1000 is worn, there is no need to distinguish between the left ear and the right ear, and a quantity of feedforward microphones can be reduced. This can reduce a volume and a weight of the earphone 1000, and help miniaturization and lightweight of the earphone 1000.

In another implementation, the second earphone body 200 may further have a first microphone (not shown in the figure) and a second microphone (not shown in the figure) that are configured for a call. The first microphone and the second microphone may be configured to pick up a speaking voice of the user. The first microphone may pick up the speaking voice of the user through the first sound pickup hole 214. The second microphone may pick up the speaking voice of the user through the second sound pickup hole 215. For example, for a manner of disposing the first microphone, refer to the manner of disposing the first feedforward microphone. For a manner of disposing the second microphone, refer to the manner of disposing the second feedforward microphone.

As shown in FIG. 14, the charging terminal 291 may include a first electrode 2911 and a second electrode 2912. Both the first electrode 2911 and the second electrode 2912 are electrically connected to the battery 240. Both the first electrode 2911 and the second electrode 2912 are embedded in the housing 209 of the second earphone body 200, and one end of each of the first electrode 2911 and the second electrode 2912 is exposed relative to the outer surface of the housing 209 of the second earphone body 200. The first electrode 2911, the second electrode 2912, the first sound pickup hole 214, and the second sound pickup hole 215 are spaced.

For example, the first electrode 2911 may be fastened to the third housing 210. One end of the first electrode 2911 may be exposed at the first charging hole 216 relative to the outer surface of the housing 209 of the second earphone body 200. The second electrode 2912 may be fastened to the third housing 210. One end of the second electrode 2912 may be exposed at the second charging hole 217 relative to the outer surface of the housing 209 of the second earphone body 200.

In another implementation, the first charging hole 216 and the second charging hole 217 may alternatively be disposed on the fourth housing 220, and the first electrode 2911 and the second electrode 2912 may alternatively be fastened to the fourth housing 220. This is not limited in this disclosure.

When the user charges the earphone 1000, the first electrode 2911 and the second electrode 2912 respectively serve as a positive electrode and a negative electrode, and are respectively configured to electrically connect to a positive electrode and a negative electrode of the battery 240. A correspondence between the first electrode 2911 and the positive electrode and a correspondence between the second electrode 2912 and the negative electrode are not fixed in this application. It may be understood that the first electrode 2911 may serve as the positive electrode, and the second electrode 2912 may serve as the negative electrode; or the first electrode 2911 may serve as the negative electrode, and the second electrode 2912 may serve as the positive electrode.

The first electrode 2911 and the second electrode 2912 may be electrically connected to the second circuit board 280. The battery 240 may be electrically connected to the second circuit board 280. The second circuit board 280 may be further configured to transmit an electrical signal between the first electrode 2911, the second electrode 2912, and the battery 240.

In some implementations, the first electrode 2911 and the second electrode 2912 may be symmetrical with respect to the O-O plane. In this way, a weight of the second earphone body 200 is symmetrically distributed with respect to the O-O plane.

As shown in FIG. 14, the second earphone body 200 may further include a second magnet 299. The second magnet 299 may be disposed in the second space 201 of the second earphone body 200, and is fastened to the third housing 210. The second magnet 299 may be configured to assist the earphone 1000 in quickly positioning when the earphone 1000 is charged in a paired earphone 1000 case. For example, the second magnet 299 may be located on a side that is of the battery 240 and that is away from the first connecting hole 218.

In some implementations, there may be two second magnets 299, and the two second magnets 299 may be symmetrical with respect to the O-O symmetry plane of the earphone 1000. In another implementation, the second magnet 299 may be alternatively fastened to the fourth housing 220.

In another implementation, there may be one second magnet 299 or three or more second magnets 299.

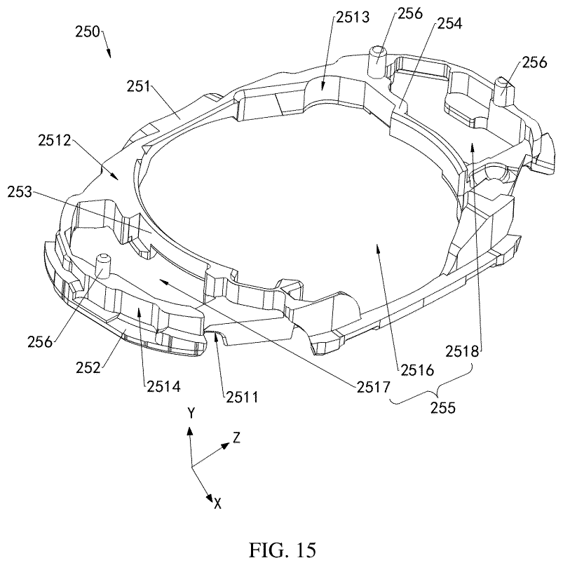

FIG. 15 is a diagram of a structure of an implementation of a mainboard bracket 250 shown in FIG. 5.

As shown in FIG. 15, the mainboard bracket 250 may include a main part 251, an extension part 252, a first limiting part 253, and a second limiting part 254. The main part 251 may be ring-shaped. The main part 251 has a first end surface 2511, a second end surface 2512, an inner side surface 2513, and an outer side surface 2514. The first end surface 2511 and the second end surface 2512 are disposed opposite to each other, and the inner side surface 2513 and the outer side surface 2514 are disposed opposite to each other. The inner side surface 2513 is connected between the first end surface 2511 and the second end surface 2512. The inner side surface 2513 encloses an accommodation space 255. The outer side surface 2514 is connected between the first end surface 2511 and the second end surface 2512. The extension part 252 is connected to the outer side surface 2514 and is located at an end that is of the outer side surface 2514 and that is close to the first end surface 2511. The first limiting part 253 and the second limiting part 254 are both connected to the inner side surface 2513 of the main part 251 and are spaced. The first limiting part 253 and the second limiting part 254 divide the accommodation space 255 into a first accommodation space 2516, a second accommodation space 2517, and a third accommodation space 2518.

In some implementations, the mainboard bracket 250 may further include a second positioning pillar 256. The second positioning pillar 256 may be fastened to the second end surface 2512 of the main part 251. There may be one or more second positioning pillars 256. When there are a plurality of second positioning pillars 256, the plurality of second positioning pillars 256 are spaced.

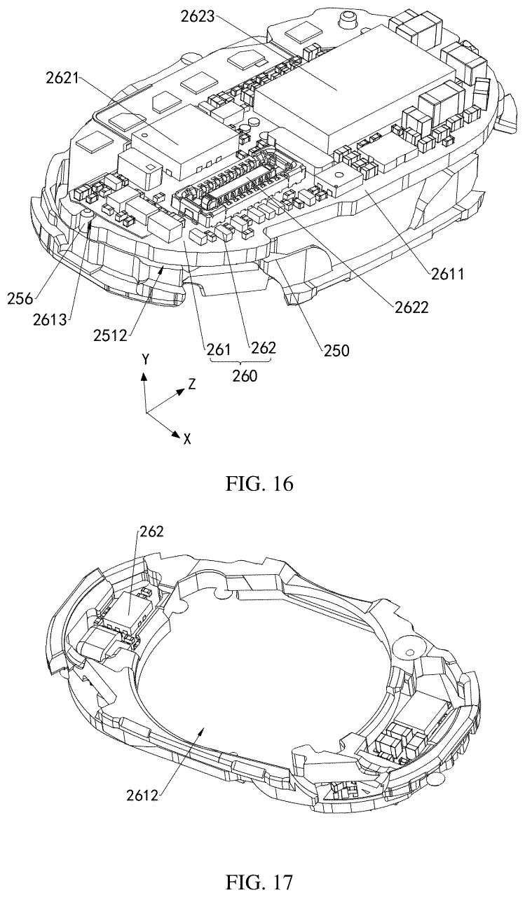

FIG. 16 is an assembly diagram of an implementation of the circuit board 261 and the mainboard bracket 250 shown in FIG. 5. FIG. 17 is a schematic view of the structure shown in FIG. 16 from a different perspective.

As shown in FIG. 16 and FIG. 17, the mainboard 260 may include the circuit board 261 and an electronic component 262 disposed on the circuit board 261. The circuit board 261 may be used as a carrier of an electronic element. For example, the electronic element may be an active component such as a chip, or may be a passive component such as a capacitor, an inductor, or a resistor. It may be understood that the electronic component 262 may have a specific function of the mainboard 260 through selection and combination of different types and quantities. A person skilled in the art can select a type and a quantity of electronic elements based on an actual requirement. This is not limited in this disclosure.

The circuit board 261 may be fastened to the second end surface 2512 of the mainboard bracket 250. For example, the circuit board 261 may include a first surface 2611 and a second surface 2612 that are disposed opposite to each other. The first surface 2611 is fastened to the second end surface 2512 of the mainboard bracket 250. The electronic component 262 may be disposed on the first surface 2611 or the second surface 2612. In other words, both surfaces of the circuit board 261 may be used to dispose the electronic component 262. A person skilled in the art may perform disposing as required.

In some implementations, the electronic component 262 may include an accelerometer 2621 (accelerometer, ACC). The accelerometer 2621 may be fastened to the second surface 2612 of the circuit board 261. The accelerometer 2621 may be configured to measure an acceleration of the second earphone body 200, to determine a space position of the second earphone body 200. In other words, a space motion status of the second earphone body 200 may be determined by using the accelerometer 2621.

In some implementations, the electronic component 262 may further include an electrical connector 2622. The electrical connector 2622 may be configured to implement electrical connection between the circuit board 261 and another signal transmission structure. For example, the mainboard 260 may include a board to board connector (Board to Board Connector, BTB), and the board to board connector is fastened to the second surface 2612 of the circuit board 261.

In some implementations, the electronic component 262 may further include a main chip 2623. The main chip 2623 may be configured to control a function of the earphone 1000. For example, the main chip 2623 may be fastened to the second surface 2612 of the circuit board 261.

In some implementations, the circuit board 261 may have an avoidance hole 2613 (as shown in FIG. 16). When the circuit board 261 may be fastened to the mainboard bracket 250, the second positioning pillar 256 may be located in the avoidance hole 2613. It may be understood that the avoidance hole 2613 and the second positioning pillar 256 are disposed, and the avoidance hole 2613 and the second positioning pillar 256 co-work with each other. In this way, in an assembly process of the circuit board 261, quick positioning can be implemented. In a subsequent assembly procedure, displacement of the circuit board 261 can be prevented.

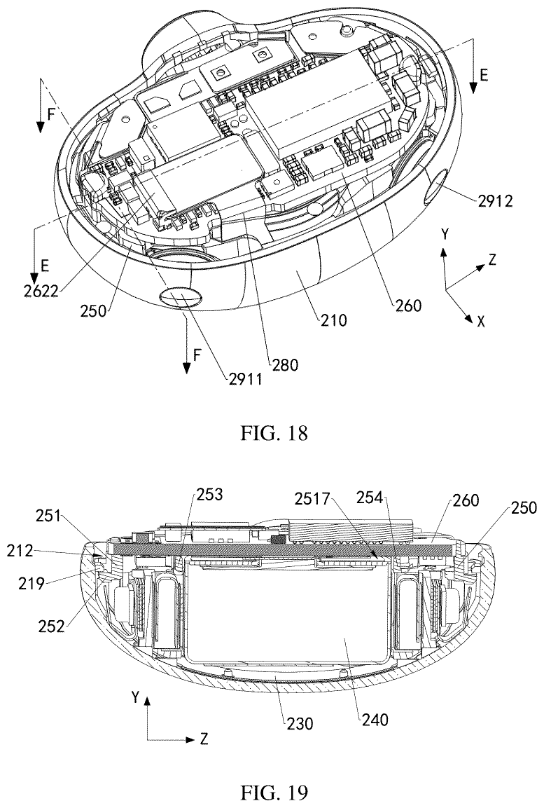

FIG. 18 is an assembly diagram of a partial structure of the second earphone body 200 shown in FIG. 5. FIG. 19 is a sectional diagram of an implementation of the second earphone body 200 shown in FIG. 18 at a section line E-E.

As shown in FIG. 18 and FIG. 19, the mainboard bracket 250 may be fastened to the inner surface 212 of the third housing 210. The circuit board 261 of the mainboard 260 is fastened to the mainboard bracket 250. In this way, the mainboard bracket 250 can be used to fasten the mainboard 260.

For example, the third housing 210 may have a boss 219. The boss 219 may be formed by protruding from the inner surface 212 of the third housing 210. The extension part 252 of the mainboard bracket 250 may be fastened to the boss 219. In a direction from the third housing 210 to the fourth housing 220, a projection of the extension part 252 on the boss 219 at least partially overlaps the boss 219. The mainboard bracket 250 may be configured to bear the mainboard 260, and may be further configured to prevent the mainboard 260 from shaking under an external force, thereby avoiding interference with working of the mainboard 260 and interference with another component inside the second earphone body 200.

In some implementations, the mainboard 260 and the battery 240 are stacked in the Y-axis direction. For example, the mainboard 260 may be located on a side that is of the battery 240 and that is away from the third housing 210.

In some implementations, the battery 240 may be partially located in the second accommodation space 2517. A part of the main part 251, the first limiting part 253, and the second limiting part 254 of the mainboard bracket 250 are disposed around the battery 240. In this way, the battery 240 may be further limited, thereby reducing a risk of displacement of the battery 240 in the X-Z direction.

In some implementations, the antenna module 230, the battery 240, and the mainboard 260 may be stacked in the Y-axis direction.

The second circuit board 280 is connected to the mainboard 260, and is electrically connected to the mainboard 260. For example, the second circuit board 280 is connected to the electrical connector 2622 (the electrical connector 2622 is illustrated in FIG. 16) on the mainboard 260, to implement electrical connection to the mainboard 260. It may be understood that the battery 240 may be electrically connected to the mainboard 260 through a flexible circuit board or a conductive cable. When the user charges the earphone 1000, a current may sequentially pass through the first electrode 2911 and the second electrode 2912, the second circuit board 280, and the mainboard 250, and finally enter the battery 240, to store energy. The second circuit board 280 may be further configured to implement electrical connection between the first feedforward microphone 273, the second feedforward microphone 274, and the mainboard 250.

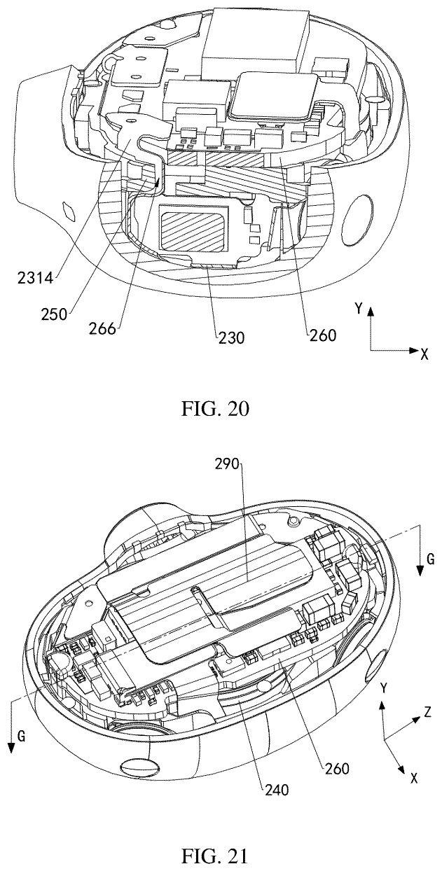

FIG. 20 is a sectional diagram of an implementation of the second earphone body 200 shown in FIG. 18 at a section line F-F.

As shown in FIG. 20, in the Y-axis direction, there is a gap between a projection of the mainboard 260 on a plane on which the mainboard bracket 250 is located and the mainboard bracket 250. In other words, the mainboard bracket 250 and the mainboard 260 may enclose a first gap 266. The first gap 266 may be configured to arrange cabling. For example, the feeding line 2314 of the antenna module 230 may be connected to the mainboard 260 through a gap between the third housing 210 and the battery 240 and the first gap 266, to power on the antenna module 230. It may be understood that the first gap 266 is disposed to help fasten a position of the feeding line 2314 of the antenna module 230, thereby improving reliability of electrical connection between the antenna module 230 and the mainboard 260.

In another implementation, a second gap (not shown in the figure) may be further enclosed between the mainboard bracket 250 and the mainboard 260, and the second circuit board 280 may also pass through the second gap to electrically connect to the mainboard 260.

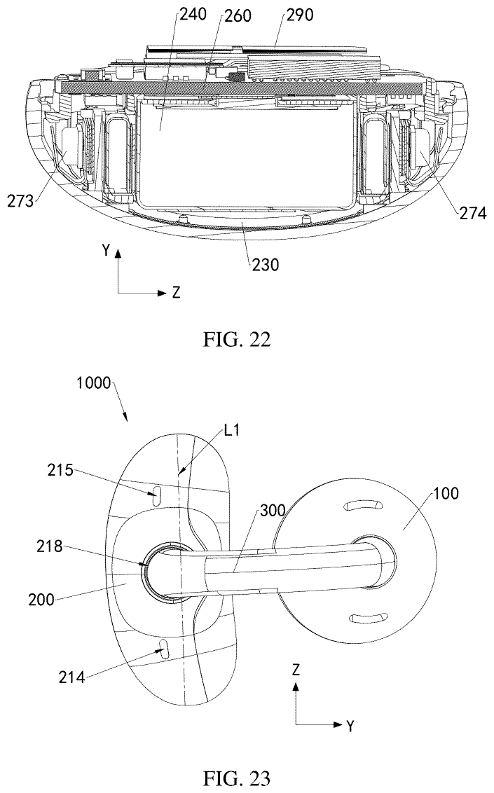

FIG. 21 is an assembly diagram of a partial structure of the second earphone body 200 shown in FIG. 5. FIG. 22 is a sectional diagram of an implementation of a structure shown in FIG. 21 at a section line G-G.

As shown in FIG. 21 and FIG. 22, the second capacitive sensor 290 may be disposed on a side that is of the mainboard 260 and that is away from the battery 240. The second capacitive sensor 290 is spaced from the first feedforward microphone 273 and the second feedforward microphone 274. The second capacitive sensor 290 may be connected to the mainboard 260, and is electrically connected to the mainboard 260. For example, the second capacitive sensor 290 may be electrically connected to the mainboard 260 through a flexible circuit board. In some implementations, the second capacitive sensor 290 may also be referred to as a proximity sensor, and may be configured to detect whether the user wears the earphone 1000. When the second capacitive sensor 290 is close to the skin of the user, capacitance of the second capacitive sensor 290 changes, and an electrical signal is generated. A distance between the second capacitive sensor 290 and the user may be determined based on a change of the electrical signal.

In some implementations, the antenna module 230, the battery 240, the mainboard 260, and the second capacitive sensor 290 may be stacked in the Y-axis direction.

FIG. 23 is a diagram of a structure of the earphone 1000 shown in FIG. 1 from a different perspective.

As shown in FIG. 23, the first sound pickup hole 214 and the second sound pickup hole 215 may be spaced from each other in the first direction, and are located on two sides of the first connecting hole 218. An end part of the connecting arm 300 is extended into the second earphone body 200 through the first connecting hole 218. In other words, the first sound pickup hole 214 and the second sound pickup hole 215 may be located on two sides of the connecting arm 300. The first sound pickup hole 214 and the second sound pickup hole 215 are located on a side that is of the long axis L1 and that is close to the connecting arm 300.

In this application, the earphone 1000 is specifically described with reference to related accompanying drawings. The earphone 1000 includes the first earphone body 100, the connecting arm 300, and the second earphone body 200. The connecting arm 300 is connected between the first earphone body 100 and the second earphone body 200. The first earphone body 100 is configured to emit sound. The second earphone body 200 is configured to pick up noise. The second earphone body 200 includes the housing and the first feedforward microphone 273. The first feedforward microphone 273 is disposed inside the housing of the second earphone body 200. The housing 209 of the second earphone body 200 has the first sound pickup hole 214, and the first feedforward microphone 273 picks up external noise of the second earphone body 200 through the first sound pickup hole 214. A length of the housing 209 of the second earphone body 200 in the first direction is greater than a length of the housing 209 in the second direction. The second earphone body 200 includes the long axis, and the long axis is a connection line between two farthest endpoints of the housing 209 of the second earphone body 200 in the first direction. The first sound pickup hole 214 is located on a side that is of the long axis and that is close to the connecting arm 300. The second direction is different from the first direction. The second direction is a direction in which an end part that is of the connecting arm 300 and that is connected to the second earphone body 200 points to the center of the second earphone body 200.

It may be understood that, in comparison with a solution in which the long axis L1 passes through the first sound pickup hole 214, the first sound pickup hole 214 is disposed on a side that is of the long axis L1 and that is close to the connecting arm 300. When the user wears the earphone 1000, a risk of sweat dripping into the first sound pickup hole 214 or the second sound pickup hole 215 can be reduced, and the first sound pickup hole 214 or the second sound pickup hole 215 is prevented from being blocked by the sweat, thereby affecting active noise reduction effect.

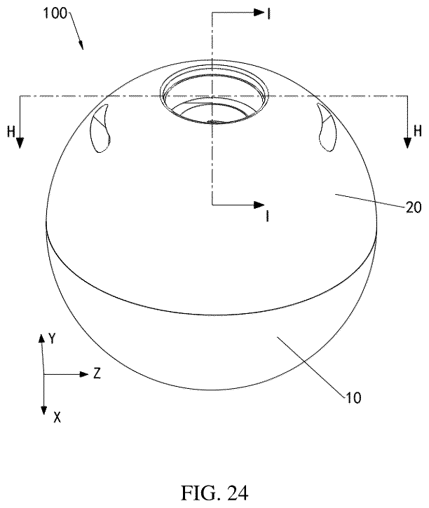

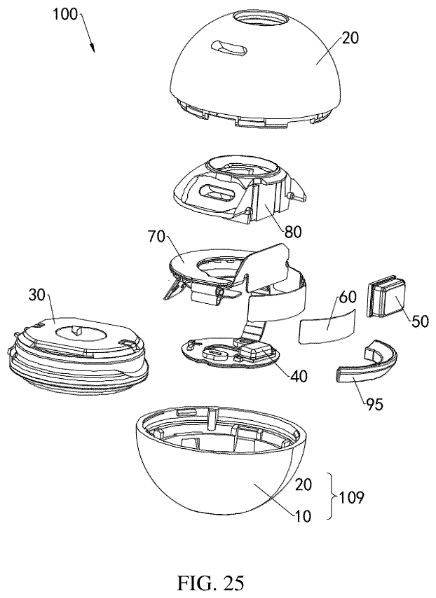

The following describes several implementations of the first earphone body 100 in detail with reference to the accompanying drawings. FIG. 24 is a diagram of a structure of an implementation of the first earphone body 100 shown in FIG. 1. FIG. 25 is an exploded diagram of a partial structure of the first earphone body 100 shown in FIG. 24.

As shown in FIG. 24 and FIG. 25, the first earphone body 100 may include a housing 109, a speaker 30 (Speaker), a feedback microphone 40 (Feedback microphone, FB mic), a vibrate pickup sensor 50 (Vibrate pickup sensor, VPU), a first capacitive sensor 60 (capacitive sensor, CAP), a first circuit board 70, and a cable bundle bracket 80. The speaker 30 (Speaker), the feedback microphone 40 (Feedback microphone, FB mic), the vibrate pickup sensor 50 (Vibrate pickup sensor, VPU), the first capacitive sensor 60 (Captive sensor, CAP), the first circuit board 70, and the cable bundle bracket 80 may all be disposed inside the housing 109 of the first earphone body 100.

For example, the housing 109 of the first earphone body 100 may include a first housing 10 and a second housing 20. The first housing 10 is connected to the second housing 20, to enclose a first space 101. The speaker 30, the feedback microphone 40, the vibrate pickup sensor 50, the first capacitive sensor 60, the first circuit board 70, and the cable bundle bracket 80 may all be disposed in the first space 101.

In some implementations, the housing 109 of the first earphone body 100 may be spherical.

In some implementations, a diameter of the housing 109 of the first earphone body 100 is within a range of 12 mm to 15 mm. For example, a diameter of a spherical appearance surface may be 12.3 mm, 13 mm, or 14.3 mm.

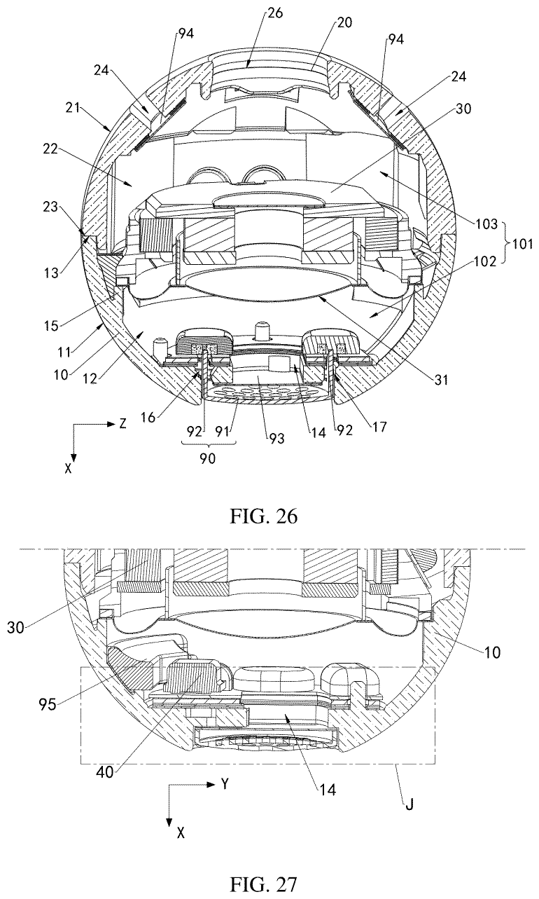

FIG. 26 is a partial sectional diagram of an implementation of the first earphone body 100 shown in FIG. 24 at a section line H-H.

As shown in FIG. 26, the first housing 10 may have an outer surface 11, an inner surface 12, and a first end surface 13. The outer surface 11 and the inner surface 12 are disposed opposite to each other, and the inner surface 12 faces the first space 101. The first end surface 13 is connected between the outer surface 11 and the inner surface 12. The second housing 20 may have an outer surface 21, an inner surface 22, and a second end surface 23. The outer surface 21 and the inner surface 22 are disposed opposite to each other, and the inner surface 22 faces the first space 101. The second end surface 23 is connected between the outer surface 21 and the inner surface 22.

When the first housing 10 is connected to the second housing 20, the first end surface 13 of the first housing 10 is connected to the second end surface 23 of the second housing 20. The outer surface 11 of the first housing 10 and the outer surface 21 of the second housing 20 may form an outer surface of the housing 109 of the first earphone body 100. The inner surface 12 of the first housing 10 and the inner surface 22 of the second housing 20 form an inner surface of the housing 109 of the first earphone body 100. The inner surface 12 of the first housing 10 and the inner surface 22 of the second housing 20 enclose the first space 101.

In some implementations, the outer surface 11 of the first housing 10 is hemispherical, and the outer surface 21 of the second housing 20 is hemispherical. The outer surface 11 of the first housing 10 and the outer surface 21 of the second housing 20 have a same radius.

In some implementations, the first housing 10 and the second housing 20 may be fastened in a manner such as adhesive bonding or a buckle.

As shown in FIG. 26, the speaker 30 may be fastened to the inner surface 12 of the first housing 10. The speaker 30 divides the first space 101 enclosed by the first housing 10 and the second housing 20 into a first sub-cavity 102 and a second sub-cavity 103. A sound-emitting surface 31 of the speaker 30 faces the first sub-cavity 102. The first housing 10 may have a first through hole 14, and the first through hole 14 communicates external space (namely, an environment in which the first earphone body 100 is located) of the first earphone body 100 and the first sub-cavity 102. The first through hole 14 is configured to transmit sound emitted by the speaker 30 out of the first earphone body 100. When the user wears the earphone 1000, the first through hole 14 is located in a concha cavity of the user, and the sound emitted by the speaker 30 may enter the ear of the user through the first through hole 14 and be received by the user. For example, the first through hole 14 may be disposed opposite to the speaker 30.

In some implementations, the first housing 10 may have a first boss 15. The first boss 15 may be located in the first sub-cavity 102. The first boss 15 may be formed by protruding from the inner surface 12 of the first housing 10 toward the first sub-cavity 102, and a surface of the first boss 15 is a part of the inner surface 12 of the first housing 10. The speaker 30 may be fastened to the first boss 15. For example, the first boss 15 may be annular, and the first boss 15 is connected to the speaker 30 in an annular manner. In this way, the speaker 30 may independently separate the first sub-cavity 102 from the second sub-cavity 103, that is, the first sub-cavity 102 and the second sub-cavity 103 may be spaced. The first sub-cavity 102 may be used as a front sound cavity of the speaker 30, and the speaker 30 is configured to transmit and interact with sound with the outside of the first earphone body 100 through the first through hole 14. The second sub-cavity 103 may be used as a rear sound cavity of the speaker 30.

The second housing 20 may have a vent hole 24. The vent hole 24 is configured to communicate the second sub-cavity 103 with external space of the first earphone body 100 (that is, the environment in which the first earphone body 100 is located), to balance air pressure of the second sub-cavity 103. For example, there may be two (first and second) vent holes 24.

In some implementations, positions of the two vent holes 24 are symmetrical with respect to the O-O plane. It may be understood that the two vent holes 24 are symmetrically arranged. In this way, when the user uses the earphone 1000, the user does not need to distinguish between the left ear and the right ear. In addition, the two vent holes 24 are symmetrically distributed. When the earphone 1000 is worn, if sweat blocks one of the vent holes 24, the other vent hole 24 can still work, to balance air pressure in the second sub-cavity 103.

In some implementations, the second housing 20 may have a second connecting hole 26. The second connecting hole 26 connects the outer surface 21 of the second housing 20 and the inner surface 22 of the second housing 20. As shown in FIG. 2, one end of the connecting arm 300 is extended into the first earphone body 100 through the second connecting hole 26.

In some implementations, the two vent holes 24 are spaced from each other in the first direction, and are located on two sides of the second connecting hole 26.

In some implementations, a connection line between the first through hole 14 and the vent hole 24 is a first connection line, and a connection line between the second connecting hole 26 and the first through hole 14 is a second connection line. The first connection line and the second connection line form an included angle. When the speaker 30 emits sound, leakage sound on the first connection line is greater than leakage sound on the second connection line. The first through hole 14 and the vent holes 24 may form a dipole sound field. For example, when the user wears the earphone 1000, the second connecting hole 26 faces a front side of the user, and the two vent holes 24 are disposed on two sides of the second connecting hole 26, to reduce sound leakage on the front side of the user.

As shown in FIG. 26, the speaker 30 may be fastened at a cross section of a maximum diameter of the first housing 10. In another implementation, the speaker 30 may alternatively be fastened to the inner surface 22 of the second housing 20, and fastened to a cross section of a maximum diameter of the second housing 20.

In some implementations, the speaker 30 is a dual-magnetic diaphragm speaker. In comparison with a conventional moving coil moving iron speaker, the speaker 30 is a dual-magnetic diaphragm speaker, so that low frequency effect in an open sound field function can be effectively improved, and a disadvantage that a sound outlet (namely, the first through hole 14) of the earphone 1000 is at a specific distance from the ear canal can be compensated.

In some implementations, the first earphone body 100 may further include a dust filter 90. The dust filter 90 is connected to the first housing 10 and is disposed in the first through hole 14. The dust filter 90 covers the first through hole 14. It may be understood that the dust filter 90 is disposed, so that impurities outside the earphone 1000 can be prevented from entering the first sub-cavity 102 of the first earphone body 100 through the first through hole 14 and interfering with working of the speaker 30. In some implementations, the dust filter 90 may be made of a metal material, so that strength of the dust filter 90 is good.

For example, the dust filter 90 may include a body part 91 and two connecting parts 92. The connecting part 92 is connected to the body part 91. The two connecting parts 92 are spaced. The first housing 10 has a second through hole 16 and a third through hole 17 that are spaced. The second through hole 16 and the third through hole 17 surround around the first through hole 14. The two connecting parts 92 are respectively connected to the second through hole 16 and the third through hole 17. The body part 91 is of a mesh structure, and covers the first through hole 14.

In some implementations, the first earphone body 100 may further include a first water-resistant and breathable film 93. The first water-resistant and breathable film 93 may be connected to the first housing 10 and cover the first through hole 14. For example, the first water-resistant and breathable film 93 may be disposed between the body part 91 of the dust filter 90 and the first housing 10. It may be understood that, the first water-resistant and breathable film 93 is disposed, so that the first sub-cavity 102 is connected to the external space of the first earphone body 100, and air pressure in the first sub-cavity 102 is balanced. In addition, external dust and water vapor can be prevented from entering the first sub-cavity 102 through the first through hole 14. This avoids affecting working of the speaker 30.

In some implementations, an area of the first through hole 14 is within a range of 5 mm² to 8 mm². For example, the area of the first through hole may be 5 mm², 6.5 mm², or 8 mm².

In some implementations, the first earphone body 100 may further include a second water-resistant and breathable film 94. The second water-resistant and breathable film 94 is connected to the inner surface 22 of the second housing 20 and covers the vent hole 24. It may be understood that, the second water-resistant and breathable film 94 is disposed, so that the second sub-cavity 103 is connected to the external space of the first earphone body 100, and air pressure in the second sub-cavity 103 is balanced. In addition, external dust and water vapor can be prevented from entering the second sub-cavity 103 through the first through hole 14. This avoids affecting working of an internal component of the first earphone body 100.

In some implementations, there are two vent holes 24, and there are also two second water-resistant and breathable films 94. The two vent holes 24 and the two second water-resistant and breathable films 94 are disposed in a one-to-one correspondence.

In some implementations, an area of the vent hole 24 is less than an area of the first through hole 14. When there are a plurality of vent holes 24, the area of the vent hole 24 is a sum of areas of the plurality of vent holes 24.

In some implementations, the area of the vent hole 24 is within a range of 1 mm² to 3 mm². For example, the area of the vent hole 24 may be 1 mm², 2 mm², or 3 mm².

FIG. 27 is a partial sectional diagram of an implementation of the first earphone body 100 shown in FIG. 24 at a section line I-I.

As shown in FIG. 27, the feedback microphone 40 may be disposed near a sound-emitting position of the speaker 30. For example, the feedback microphone 40 may be disposed in the first sub-cavity 102. The feedback microphone 40 may be disposed around the first through hole 14. When the user wears the earphone 1000, the feedback microphone 40 may be located in the concha cavity of the user and near an ear canal. Sound near the ear canal of the user may be picked up by the feedback microphone 40 through the first through hole 14. It may be understood that, the feedback microphone 40 is disposed, and the feedback microphone 40 is disposed near the speaker 30, so that the feedback microphone 40 may be configured to: pick up noise near the ear canal of the user, and feed back sound on a side of the speaker 30 to a chip to output an anti-phase sound wave to cancel noise in the ear. Therefore, user experience is good.

In some implementations, the first earphone body 100 may further include a first magnet 95. For example, the first magnet 95 may be located in the first sub-cavity 102 and is fastened to the inner wall surface of the first housing 10. When the earphone 1000 is accommodated in an earphone case, the first magnet 95 may be configured to co-work with a magnet in the earphone case to generate an attraction, and fasten a position of the first earphone body 100 in the earphone 1000 box.

In some implementations, the first magnet 95 is a long strip with an arc. In this way, the first magnet may fit the first housing 10 in a hemispherical shape more closely, and arrangement of components in the first sub-cavity 102 may be more compact. In another implementation, the first magnet 95 may be circular or in another shape.

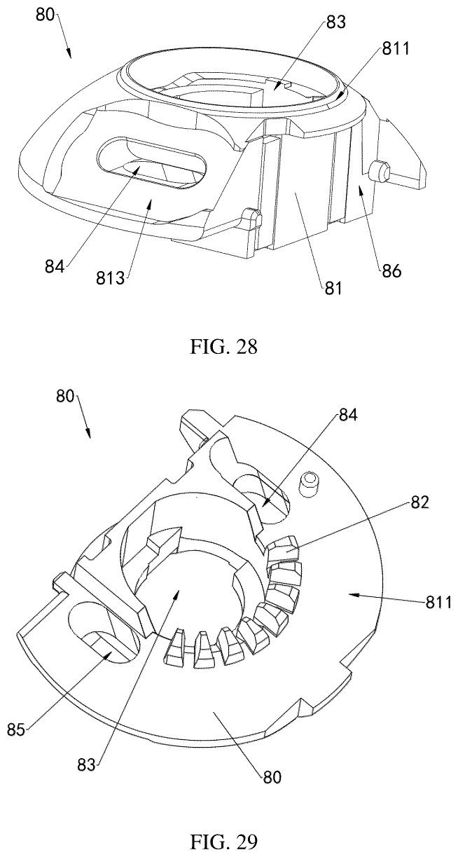

FIG. 28 is a diagram of a structure of an implementation of the cable bundle bracket 80 shown in FIG. 25. FIG. 29 is a diagram of a structure of the cable bundle bracket 80 shown in FIG. 28 from a different perspective.

As shown in FIG. 28 and FIG. 29, the cable bundle bracket 80 may include a bracket body 81 and a plurality of baffle plates 82. The bracket body 81 includes a top surface 811, a bottom surface 812, and a peripheral side surface 813. The top surface 811 and the bottom surface 812 are disposed opposite to each other, and the peripheral side surface 813 is connected between the top surface 811 and the bottom surface 812. The cable bundle bracket 80 has a cable threading channel 83, a first air pipe 84, and a second air pipe 85. The cable threading channel 83, the first air pipe 84, and the second air pipe 85 are spaced and are not connected to each other. The cable threading channel 83 is connected to the top surface 811 and the bottom surface 812. The first air pipe 84 is connected to the bottom surface 812 and the peripheral side surface 813. The second air pipe 85 is connected to the bottom surface 812 and the peripheral side surface 813. The top surface 811 of the bracket body 81 is a top surface of the cable bundle bracket 80. The peripheral side surface 813 of the bracket body 81 is a peripheral side surface of the cable bundle bracket 80.

The plurality of baffle plates 82 are fastened to the bottom surface 812 of the bracket body 81. The plurality of baffle plates 82 surround the cable threading channel 83 and are spaced from each other. It may be understood that a quantity of baffle plates 82 may be adjusted based on an actual situation.

In some implementations, the cable bundle bracket 80 may have an accommodation groove 86. The accommodation groove 86 may be configured to place the vibrate pickup sensor 50. For example, the accommodation groove 86 may form an opening on the bottom surface 812 and the peripheral side surface 813 of the bracket body 81. The accommodation groove 86 may be spaced from the cable threading channel 83, the first air pipe 84, and the second air pipe 85.

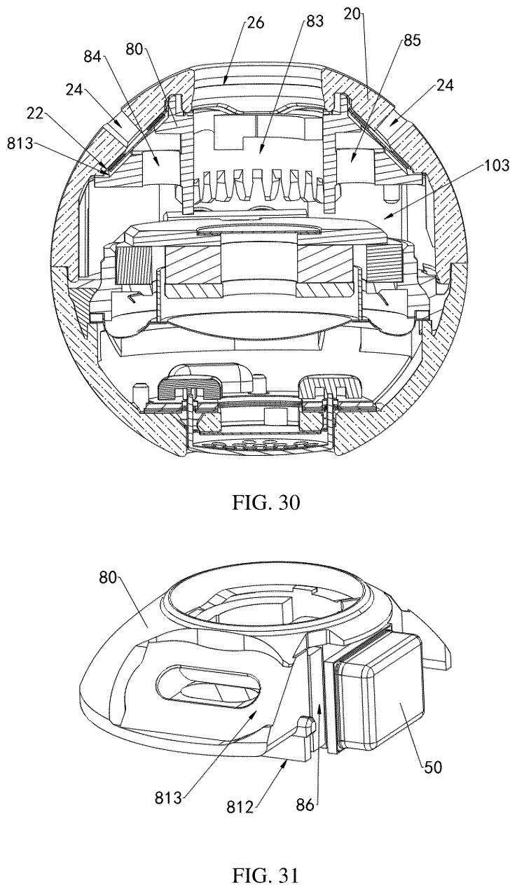

FIG. 30 is a partial sectional diagram of an implementation of the first earphone body 100 shown in FIG. 24 at a section line H-H.

As shown in FIG. 30, the cable bundle bracket 80 is fastened to the inner surface 22 of the second housing 20. For example, the peripheral side surface 813 of the cable bundle bracket 80 is connected to the inner surface 22 of the second housing 20. It may be understood that the peripheral side surface 813 of the cable bundle bracket 80 may be designed based on a shape of the inner surface 22 of the second housing 20, so that a shape of the peripheral side surface 813 roughly matches the shape of the inner surface 22 of the second housing 20. For example, the cable bundle bracket 80 may be roughly in a frustum shape. In this way, a connection area between the cable bundle bracket 80 and the second housing 20 can be increased, and connection strength can be enhanced. In some implementations, the cable bundle bracket 80 may be fastened to the second housing 20 through adhesive bonding.

The bottom surface 812 of the bracket body 81 faces the speaker 30. The first air pipe 84 and the second air pipe 85 may be disposed opposite to the two vent holes 24 and are connected. In this way, the second sub-cavity 103 may be connected to the outside through the first air pipe 84, the second air pipe 85, and the two vent holes 24, to implement air pressure balance in the second sub-cavity 103.

In some implementations, the second connecting hole 26 and the cable threading channel 83 of the cable bundle bracket 80 are disposed opposite to each other.

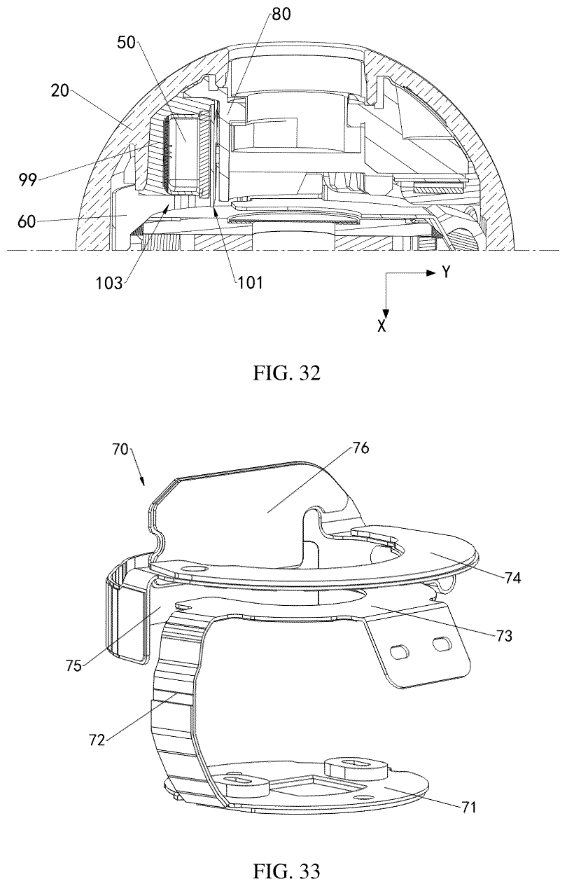

FIG. 31 is an assembly diagram of an implementation of the vibrate pickup sensor 50 and the cable bundle bracket 80 shown in FIG. 25. FIG. 32 is a partial sectional diagram of an implementation of the first earphone body 100 shown in FIG. 24 at a section line I-I.

As shown in FIG. 31 and FIG. 32, the vibrate pickup sensor 50 may be fastened to the accommodation groove 86 of the cable bundle bracket 80. For example, the accommodation groove 86 may form an opening on the bottom surface 812 and the peripheral side surface 813 of the bracket body 81. The vibrate pickup sensor 50 may be fastened to space surrounded by the accommodation groove 86 of the cable bundle bracket 80 and the second housing 20.

The second earphone body 200 may further include a buffer member 99. The buffer member 99 may be filled in a gap between the second housing 20, the vibrate pickup sensor 50, and the cable bundle bracket 80. In this way, the buffer member 99 may help fasten a position of the vibrate pickup sensor 50, and play a buffer role when the vibrate pickup sensor 50 is impacted by an external force. For example, the buffer member 99 may be glue. In this way, the buffer member 99 can further strengthen connection between the second housing 20 and the cable bundle bracket 80 while performing a buffer function, thereby improving reliability.

The first capacitive sensor 60 is disposed in the first space 101. For example, the first capacitive sensor 60 may be connected to the inner surface 22 of the second housing 20. It may be understood that, in some implementations, the first capacitive sensor 60 may also be referred to as a proximity sensor, and may be configured to detect whether a user wears the earphone 1000. When the first capacitive sensor 60 is close to the skin of the user, capacitance of the first capacitive sensor 60 changes, and an electrical signal is generated. A distance between the first capacitive sensor 60 and the user may be determined based on a change of the electrical signal.

FIG. 33 is a diagram of a structure of an implementation of the first circuit board 70 shown in FIG. 25.

As shown in FIG. 33, the first circuit board 70 may include a first part 71, a second part 72, a third part 73, a fourth part 74, a fifth part 75, and a sixth part 76. The second part 72 is connected between the first part 71 and the third part 73. The third part 73 is connected between the second part 72 and the fourth part 74. The fourth part 74 is connected between the third part 73 and the fifth part 75. The sixth part 76 is connected to the fourth part 74.

In some implementations, the first part 71, the second part 72, the third part 73, the fourth part 74, the fifth part 75, and the sixth part 76 may be integrated into one structural part. For example, the first circuit board 70 may be made of a flexible circuit board. In this way, the first circuit board 70 may be cut into any shape based on a device that needs to be connected and a position. Then, a corresponding part and a corresponding device are connected, and the first circuit board 70 may be bent into a preset shape. In comparison with a solution in which electrical connection is implemented by using a structure such as a cable, assembly of the flexible circuit board is easy, and reliability of the electrical connection is good. In another implementation, the first part 71, the second part 72, the third part 73, the fourth part 74, the fifth part 75, and the sixth part 76 may be connected through a conducting wire.

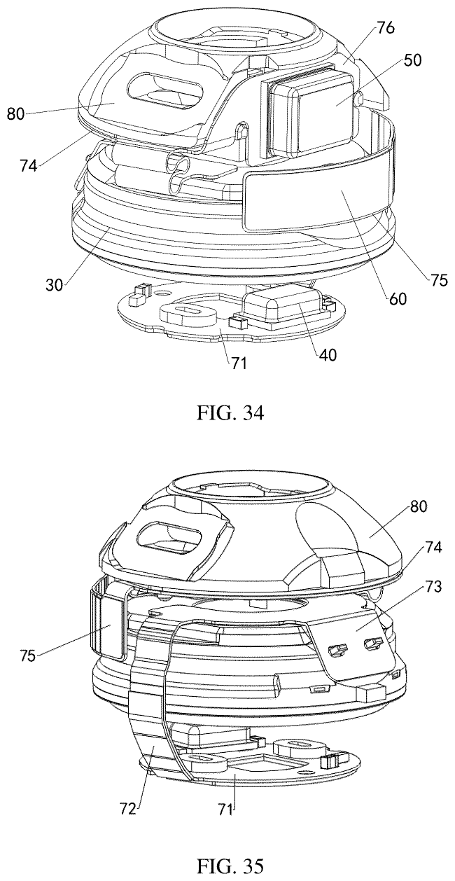

FIG. 34 is a diagram of a partial structure of an implementation of the first earphone body 100 shown in FIG. 24. FIG. 35 is a schematic view of the structure shown in FIG. 34 from a different perspective.

As shown in FIG. 34 and FIG. 35, the feedback microphone 40 is connected to the first part 71 of the first circuit board 70, and is electrically connected to the first part 71. The speaker 30 is connected to the third part 73 of the first circuit board 70, and is electrically connected to the third part 73. The fourth part 74 may be fastened to the bottom surface of the cable bundle bracket 80. The first capacitive sensor 60 is connected to the fifth part 75 of the first circuit board 70, and is electrically connected to the fifth part 75. The vibrate pickup sensor 50 is connected to the sixth part 76 of the first circuit board 70, and is electrically connected to the sixth part 76.

The fourth part 74 may be configured to connect to a signal line, and transmit signals of the speaker 30, the cable bundle bracket 80, the vibrate pickup sensor 50, the first capacitive sensor 60, and the feedback microphone 40 to the second earphone body 200.

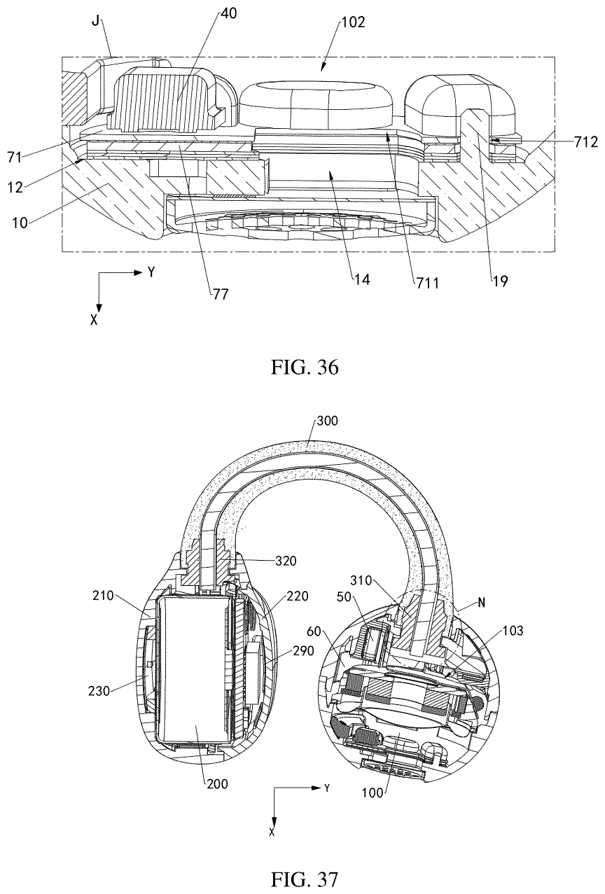

FIG. 36 is an enlarged diagram of an implementation of a structure shown in FIG. 27 at a position J.

As shown in FIG. 36, the first housing 10 of the first circuit board 70 may be connected to the inner surface 12 of the first housing 10. The feedback microphone 40 is connected to a surface that is of the first part 71 and that is away from the first housing 10. In the X-axis direction, the first part 71 may be disposed opposite to the first through hole 14. For example, the first part 71 may have a penetrating hole 711. In the X-axis direction, the penetrating hole 711 may be disposed opposite to and connected to the first through hole 14.

In some implementations, the first housing 10 may have a positioning pin 19. The positioning pin 19 may be disposed in the first sub-cavity 102. The positioning pin 19 may be configured to assist in quickly positioning the first part 71 in a process of mounting the first part 71 to the first housing 10. The first part 71 may correspondingly have a positioning hole 712, and the positioning pin 19 is at least partially located in the positioning hole 712. The positioning hole 712 and the penetrating hole 711 may be connected, or may be spaced.

In some implementations, the first circuit board 70 may further include a first reinforcement plate 77, and the first reinforcement plate 77 is connected to a surface that is of the first part 71 and that is away from the feedback microphone 40. For example, the feedback microphone 40 is connected to a surface that is of the first part 71 and that is away from the first housing 10. The first reinforcement plate 77 is connected between the first part 71 and the first housing 10. The first reinforcement plate 77 is configured to reinforce the first part 71. In another implementation, a reinforcement plate (not shown in the figure) may be disposed at another position of the first circuit board 70, to increase local strength of the first circuit board 70.

FIG. 37 is a sectional diagram of an implementation of the earphone 1000 shown in FIG. 1 on an O-O plane.

As shown in FIG. 37, the vibrate pickup sensor 50 of the first earphone body 100 is connected to a side that is of the cable bundle bracket 80 and that is close to the second earphone body 200. When the user wears the earphone 1000, the first earphone body 100 is clipped in a concha cavity of the user, and the second earphone body 200 is located on a side that is outside an ear of the user and that is away from the first earphone body 100. In other words, the ear of the user is located between the first earphone body 100 and the second earphone body 200. The vibrate pickup sensor 50 of the first earphone body 100 is connected to a side that is of the cable bundle bracket 80 and that is close to the second earphone body 200, so that the vibrate pickup sensor 50 can be close to the ear of the user, and can better pick up a vibration of the user speaking, thereby facilitating call noise reduction.

The third housing 210 of the second earphone body 200 is connected to a side that is of the fourth housing 220 and that is away from the first earphone body 100. The antenna module 230 is fastened to the third housing 210. The antenna module 230 may be located on a side that is of the second earphone body 200 and that is away from ear tissue. In this way, interference caused to the antenna module 230 during signal receiving and sending in a working process is small.

The first capacitive sensor 60 may be located inside the housing 109 of the first earphone body 100. The second capacitive sensor 290 may be located inside the housing 209 of the second earphone body 200. The second earphone body 200 may further include a controller, and the controller may be electrically connected to the first capacitive sensor 60 and the second capacitive sensor 290. For example, the controller may be located on the main chip 2623 (shown in FIG. 16).

For example, the first capacitive sensor 60 is connected to the inner surface 22 of the second housing 20, and is located on a side that is of the inner surface 22 and that is close to the second earphone body 200. The second capacitive sensor 290 is connected to the inner surface 222 of the fourth housing 220. In other words, the second capacitive sensor 290 is located on a side that is of the second earphone body 200 and that is close to the first earphone body 100. In this way, when the user wears the earphone 1000, the first capacitive sensor 60 and the second capacitive sensor 290 are close to the ears of the user, and detection results of the first capacitive sensor 60 and the second capacitive sensor 290 are more accurate.

The earphone 1000 has the first capacitive sensor 60 on the first earphone body 100 and the second capacitive sensor 290 on the second earphone body 200. The first capacitive sensor 60 is configured to obtain a first capacitance value in a first environment, the second capacitive sensor 290 is configured to obtain a second capacitance value in a second environment, and the controller is configured to determine, based on the first capacitance value and the second capacitance value, whether the user wears the earphone 1000, that is, perform wearing detection on the earphone 1000. For example, wearing detection may include the following three scenarios.

(1) When the user correctly wears the earphone 1000, the first capacitive sensor 60 and the second capacitive sensor 290 can closely fit the auricle of the user, and form a specific capacitance value based on the pressure. In addition, the first capacitive sensor 60 and the second capacitive sensor 290 are close to the ear of the user, and a difference value between the first capacitance value generated by the first capacitive sensor 60 and the second capacitance value generated by the second capacitive sensor 290 is small.

For example, when the user correctly wears the earphone 1000, the first earphone body 100 may be clipped in the concha cavity of the user, and the first environment is the concha cavity of the user. The second earphone body 200 is located on a side that is outside an ear of the user and that is away from the first earphone body 100. The second environment is a side that is outside the ear of the user and that is away from the first earphone body 100.

(2) When the user does not wear the earphone 1000, and there is no obstacle between the first capacitive sensor 60 and the second capacitive sensor 290, pressure on the first capacitive sensor 60 and the second capacitive sensor 290 is small, and the first capacitive sensor 60 generates a specific first capacitance value. The second capacitive sensor 290 generates a specific second capacitance value. A difference value between the first capacitance value generated by the first capacitive sensor 60 and the second capacitance value generated by the second capacitive sensor 290 is small.

(3) When the user picks up the earphone 1000 or another obstacle covers any one of the first capacitive sensor 60 and the second capacitive sensor 290, one of the first capacitive sensor 60 and the second capacitive sensor 290 is close to the obstacle, and the other is far away. In this case, a difference value between the capacitance value generated by the first capacitive sensor 60 and the capacitance value generated by the second capacitive sensor 290 is large.

It can be understood that the controller may determine, based on absolute values of capacitance generated by the first capacitive sensor 60 and the second capacitive sensor 290, whether the earphone 1000 is in the scenario (1) or the scenario (2), and determine, based on a difference value (namely, a relative value of the capacitance) between the capacitance generated by the first capacitive sensor 60 and the second capacitive sensor 290, whether the earphone 1000 is in the scenario (3).

It can be understood that, in comparison with a solution in which only the first capacitive sensor 60 or the second capacitive sensor 290 is disposed, in this application, the first capacitive sensor 60 is disposed on the first earphone body 100, and the second capacitive sensor 290 is disposed on the second earphone body 200. In this way, a risk of accidental touch can be reduced, and wearing detection precision of the earphone 1000 can be improved.

As shown in FIG. 37, in the length direction of the connecting arm 300, the connecting arm 300 has the first end part and the second end part that are spaced from each other, the first end part is connected to the first earphone body 100, and the second end part is connected to the second earphone body 200. In some implementations, the central axis direction of the first end part and the central axis direction of second end part are arranged at an angle ranging from 11.4° to 26°. For example, the included angle may be 11.4°, 15°, 20°, or 26°. It can be understood that, in comparison with a solution in which the central axis direction of the first end part of the connecting arm 300 and the central axis direction of the second end part of the connecting arm 300 are disposed in parallel, the first end part and the second end part of the connecting arm 300 are disposed at a specific included angle. When the user wears the earphone 1000, relative positions of the first earphone body 100 and the second earphone body 200 can better fit an ear inclination angle and a contour curve of the user. This effectively reduces a pressing feeling of the first earphone body 100 and the second earphone body 200 of the earphone 1000 on the earphone 1000, and improves user experience.

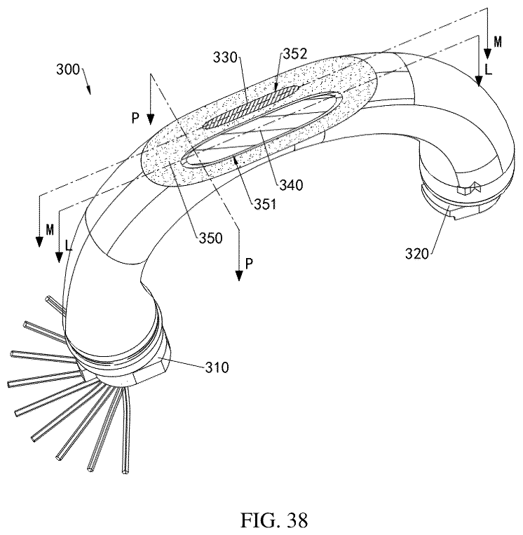

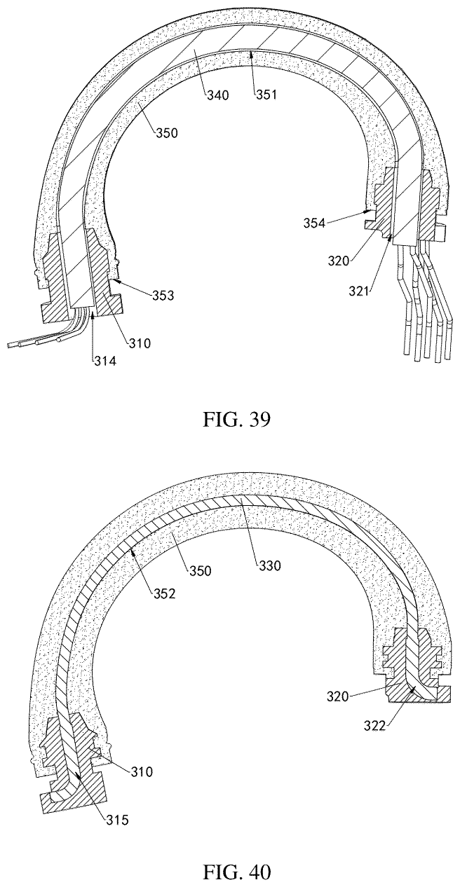

The following describes several implementations of the connecting arm 300 in detail with reference to the accompanying drawings. FIG. 38 is a sectional diagram of an implementation of the connecting arm 300 shown in FIG. 1 at a section line K-K. FIG. 39 is a sectional diagram of an implementation of the connecting arm 300 shown in FIG. 38 at a section line L-L. FIG. 40 is a sectional diagram of an implementation of the connecting arm 300 shown in FIG. 38 at a section line M-M.

As shown in FIG. 38, FIG. 39, and FIG. 40, the connecting arm 300 may include a first connecting member 310, a second connecting member 320, a support member 330, a cable bundle 340, and a pipe body 350. The pipe body 350 is sleeved on the support member 330 and the cable bundle 340, is configured to protect the support member 330 and the cable bundle 340, and may be further configured to insulate the cable bundle 340. The support member 330 is configured to enable the connecting arm 300 to be in a preset shape. The cable bundle 340 is configured to transmit an electrical signal.

For example, the pipe body 350 has a first channel 351 and a second channel 352 that are spaced from each other. Both the first channel 351 and the second channel 352 are disposed in a length direction of the pipe body 350. The pipe body 350 has a first end and a second end that are disposed opposite to each other. The first connecting member 310 is connected to the first end, and the second connecting member 320 is connected to the second end. An end surface of the first end of the pipe body 350 is a first end surface 353. An end surface of the second end of the pipe body 350 is a second end surface 354.

In some implementations, the pipe body 350 may be made of an insulating material, for example, thermoplastic urethane (Thermoplastic Urethane, TPU).

As shown in FIG. 39, the middle part of the cable bundle 340 may be located in the first channel 351, and two ends of the cable bundle 340 are respectively exposed at the first end surface 353 and the second end surface 354. In some implementations, the first connecting member 310 may have a first penetrating hole 314. The first penetrating hole 314 penetrates the first connecting member 310 in a length direction of the first connecting member 310. The second connecting member 320 may have a second penetrating hole 321. The second penetrating hole 321 penetrates the second connecting member 320 in a length direction of the first connecting member 310 and the second connecting member 320. One end of the support member 330 may penetrate the first penetrating hole 314 and be exposed, and the other end may penetrate the second penetrating hole 321 and be exposed.

As shown in FIG. 40, the first connecting member 310 may have a first cavity 315. The first cavity 315 and the first penetrating hole 314 may be spaced. The second connecting member 320 may have a second cavity 322. The second cavity 322 and the second penetrating hole 321 may be spaced. The middle part of the support member 330 may be located in the second channel 352. One end of the support member 330 may be located in the first cavity 315, and the other end may be located in the second cavity 322.

In some implementations, the support member 330 may be a deformable metal material, and is specifically a metal strip. Alternatively, the support member 330 may be an elastic metal or another material. For example, the support member 330 may be a metal wire made of a memory alloy material. It may be understood that, in comparison with a solution in which the support member 330 is prepared by using a common metal material, the support member 330 is prepared by using memory alloy, so that the first end part and the second end part of the connecting arm 300 can always be kept within a specific distance range, and the support member 330 is prevented from losing an initial shape after being stretched for a plurality of times.

In some implementations, a central axis direction of the first connecting member 310 is approximately the same as a central axis direction of the first end part of the connecting arm 300, and a central axis direction of the second connecting member 320 is approximately the same as a central axis direction of the second end part of the connecting arm 300. Alternatively, the central axis direction of the first connecting member 310 and the central axis direction of the second connecting member 320 may be disposed at an included angle ranging from 11.4° to 26°. For example, the included angle may be 11.4°, 15°, 20°, or 26°.

It may be understood that the central axis direction of the first connecting member 310 and the central axis direction of the second connecting member 320 may be implemented by using a shape of the support member 330 prepared by using the memory alloy. First, the support member 330 made of the memory alloy is set to a preset shape, then the support member 330 passes through the first channel 351 of the pipe body 350, one end is fastened to the first connecting member 310, and the other end is fastened to the second connecting member 320. Then, the support member 330 is restored to the preset shape under a specific condition. In this case, a shape of the pipe body 350 may change with a change of the shape of the support member 330. Finally, the central axis direction of the first connecting member 310 and the central axis direction of the second connecting member 320 may be disposed at a preset included angle.

In some implementations, the central axis direction of the first end of the pipe body 350 and the central axis direction of the second end of the pipe body 350 may also be disposed at an included angle.

As shown in FIG. 38, there is a gap between the cable bundle 340 and a wall surface of the first channel 351. It can be understood that, there is the gap between the first channel 351 and the cable bundle 340, so that when the connecting arm 300 is bent, a deformation degree of the cable bundle 340 may be less than a deformation degree of the pipe body 350. In other words, when the connecting arm 300 is bent, a stretching amount of the cable bundle 340 is less than a stretching amount of the pipe body 350. In this way, the cable bundle 340 is not easily broken, and has a long service life.

It can be understood that the connecting arm 300 may be configured to connect the first earphone body 100 and the second earphone body 200, and implement signal transmission between the first earphone body 100 and the second earphone body 200. The following describes, in detail with reference to the accompanying drawings, an implementation in which the connecting arm 300 is connected to the first earphone body 100 and the second earphone body 200, and a specific implementation in which the connecting arm 300 is configured to implement signal transmission between the first earphone body 100 and the second earphone body 200.

As shown in FIG. 37, when the connecting arm 300 is connected between the first earphone body 100 and the second earphone body 200, the first connecting member 310 is connected to the first earphone body 100. The second connecting member 320 is connected to the second earphone body 200.

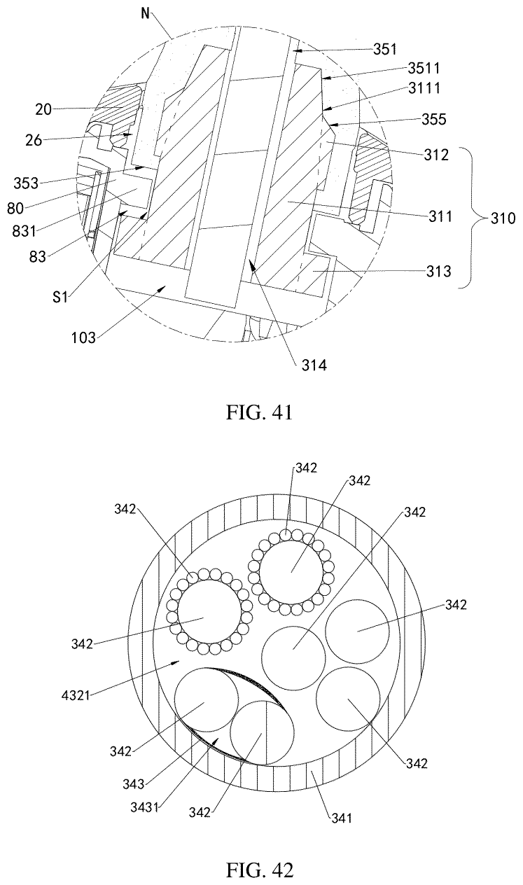

FIG. 41 is an enlarged diagram of an implementation of a structure shown in FIG. 37 at a position N.

As shown in FIG. 37 and FIG. 41, the first connecting member 310 may include a body part 311, a first protrusion 312, and a second protrusion 313 (in FIG. 41, the body part 311, the first protrusion 312, and the second protrusion 313 are schematically distinguished by using dashed lines). The first protrusion 312 and the second protrusion 313 are fastened to a side surface 3111 of the body part 311. In a length direction of the first connecting member 310, the first protrusion 312 and the second protrusion 313 are spaced. One end of the first connecting member 310 is connected to the pipe body 350, and the other end is connected to the first earphone body 100.

For example, a wall surface 3511 of the first channel 351 may be recessed to form a first groove 355. The first groove 355 and the first end surface 353 are spaced. The first protrusion 312 and a part of the body part 311 of the first connecting member 310 may be located in the first groove 355. In addition, in the length direction of the first connecting member 310, the first end surface 353 is partially located between the first protrusion 312 and the second protrusion 313. It may be understood that the first protrusion 312 may be used as a limiting structure to prevent the pipe body 350 from falling off the first connecting member 310.

The first groove 355 may be connected to the first channel 351. When the first connecting member 310 is fastened to the pipe body 350, the first penetrating hole 314 is connected to the first channel 351. In this way, one end of the cable bundle 340 may enter the second sub-cavity 103 of the first earphone body 100 after passing through the first penetrating hole 314.

In some implementations, the first protrusion 312 may be annular, and is sleeved and connected to the side surface 3111 of the body part 311. In other implementations, the first protrusion 312 may alternatively include a plurality of sub-protrusions, and the plurality of sub-protrusions are connected to the side surface 3111 of the body part 311 at intervals.

In some implementations, when the pipe body 350 is made of TPU, a TPU material is elastic, and a size of the first groove 355 may be designed to be slightly less than that of the first protrusion 312 of the first connecting member 310. Further, a wall surface of the first groove 355 may abut against the first protrusion 312 and the body part 311, and connection strength between the pipe body 350 and the first connecting member 310 is better.

In some implementations, when the first connecting member 310 is connected to the first earphone body 100, the first connecting member 310 is connected to the second housing 20. For example, a part of the first connecting member 310 is located in the cable threading channel 83 of the cable bundle bracket 80 and the second connecting hole 26 of the second housing 20. An inner wall surface of the cable threading channel 83 of the cable bundle bracket 80 may protrude to form a bump 831. In the length direction of the first connecting member 310, the bump 831 is located between the first protrusion 312 and the second protrusion 313 of the first connecting member 310, and is adjacent to the first end surface 353 of the pipe body 350. It may be understood that the bump 831 of the cable bundle bracket 80 may be used as a limiting structure, to prevent the first connecting member 310 from falling off the first earphone body 100 in the X-axis direction.

It may be understood that for a manner in which the second connecting member 320 is connected to the pipe body 350 and the second earphone body 200, refer to the manner in which the first connecting member 310 is connected to the pipe body 350 and the first earphone body 100. Details are not described herein again. When the second connecting member 320 is connected to the second earphone body 200, the second connecting member 320 may be fastened to the third housing 210 of the second earphone body 200.

In some implementations, the first end of the pipe body 350 may alternatively be partially located in the third through hole 17. In this case, the pipe body 350 is located between the second housing 20 and the first connecting member 310.

In some implementations, there may be a third gap S1 between the connecting arm 300 and the first earphone body 100. For example, the third gap S1 may be enclosed by the first connecting member 310, the first end surface 353 of the pipe body 350, and the inner wall surface of the cable threading channel 83 of the cable bundle bracket 80. When the first connecting member 310 is fastened to the first earphone body 100 through adhesive bonding, glue may be injected into the third gap S1 to implement fixed connection between the first connecting member 310 and the first earphone body 100. Similarly, there may also be a fourth gap S2 (not shown in the figure) between the second connecting member 320 and the second earphone body 200. When the second connecting member 320 is also fastened to the second earphone body 200 through adhesive bonding, glue may be injected into the fourth gap S2 to implement fixed connection between the second connecting member 320 and the second earphone body 200.

In some implementations, the third gap S1 may be greater than the fourth gap S2. It may be understood that, in a process of assembling the connecting arm 300, the first earphone body 100, and the second earphone body 200, due to an assembly tolerance, when the included angle between the central axis direction of the first end of the pipe body 350 and the central axis direction of the second end of the pipe body 350 does not reach a preset ideal angle, the third gap S1 between the first connecting member 310 and the first earphone body 100 may be used for fine adjustment. It should be noted that, when the first connecting member 310 is fastened to the first earphone body 100 by using the glue, the fine adjustment process needs to be completed before the glue solidifies.

In another implementation, the third gap S1 may be less than the fourth gap S2. In this case, fine adjustment may be performed by using the fourth gap S2 between the second connecting member 320 and the second earphone body 200.

FIG. 42 is a sectional diagram of an implementation of the cable bundle 340 shown in FIG. 38 at a section line P-P.

As shown in FIG. 42, the cable bundle 340 may be a set of a plurality of signal lines 341. For example, the cable bundle 340 may include the plurality of signal lines 341 and a first packaging member 342. A first mounting channel 4321 is disposed on the first packaging member 342 in a length direction of the first packaging member 342. A middle part of the signal line 341 may be located in the first mounting channel 4321, and two ends of the signal line 341 are exposed outside the first mounting channel 4321. The first packaging member 342 may be configured to make nine signal lines 341 into an entirety, to facilitate mounting.

In some implementations, the cable bundle 340 may include the nine signal lines. The nine signal lines 341 are respectively one signal line 341 configured to transmit a power supply, one signal line 341 configured to be grounded, two signal lines 341 configured to connect to a capacitive sensor, two signal lines 341 configured to connect to a feedback microphone, two signal lines 341 configured to connect to a vibrate pickup sensor, and two signal lines 341 configured to connect to a speaker. It may be understood that a quantity and a type of signal lines 341 included in the cable bundle 340 may be adjusted based on a component disposed in the first earphone body 100. This is not limited in this application.

In some implementations, the signal line 341 configured to transmit the power supply is a first signal line, and the signal line 341 configured to connect to the speaker is a second signal line. The cable bundle 340 may further include a second packaging member 343. The second packaging member 343 may be configured to separately package two signal lines 341 used to connect to the speaker 30, so that the two signal lines 341 form an entirety. A second mounting channel 3431 is disposed on the second packaging member 343 in a length direction of the second packaging member 343. The two first signal lines are assembled in the second mounting channel 3431, and two ends of the two first signal lines are exposed outside the second mounting channel 3431. In this case, the two first signal lines and the second packaging member 343 form a sub-cable bundle. The sub-cable bundle and the first signal line are jointly assembled in the first mounting channel 4321.

It may be understood that a signal of the speaker 30 is easily affected by another signal, and has a high crosstalk requirement. The signal line 341 of the speaker 30 is separately wrapped by using the second packaging member 343. In other words, the two signal lines 341 configured to connect the speaker 30 are independently disposed. Then, the two signal lines 341 are wrapped together with another signal line 341 by using the first packaging member 342. The signal of the speaker 30 is not easily interfered by a line of another signal, and sound effect of the earphone 1000 is good. In another implementation, a signal line of the vibrate pickup sensor also has a high crosstalk requirement. Therefore, the two signal lines 341 configured to connect the vibrate pickup sensor may also be independently disposed. In this case, the cable bundle 340 may further include a third packaging member (not shown in the figure). The third packaging member may be configured to wrap the two signal lines 341 configured to connect the vibrate pickup sensor.

In some implementations, a signal line 341 with a low crosstalk requirement in the signal line 341 may be in a form of a twisted pair. For example, the two signal lines 341 configured to connect the capacitive sensor are in the form of the twisted pair. It may be understood that, in comparison with a solution in which the two signal lines 341 configured to connect the capacitive sensor are separately disposed, the two signal lines 341 configured to connect the capacitive sensor are in the form of the twisted pair, so that a gap between the two signal lines 341 can be greatly reduced, and a cross-sectional area of the cable bundle 340 can be reduced. Further, the connecting arm 300 can be disposed to be thin.

In some implementations, the two signal lines 341 configured to connect the feedback microphone 40 may also be in the form of the twisted pair.

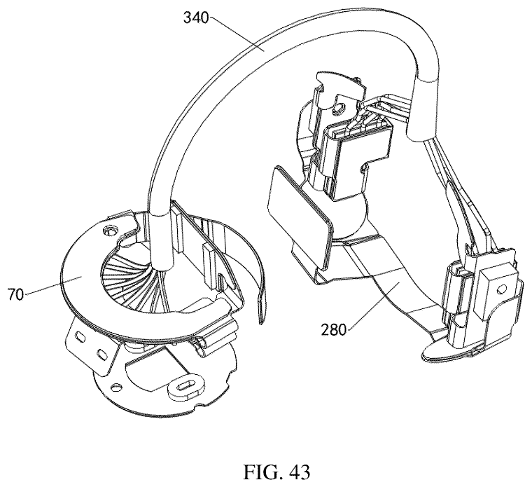

FIG. 43 is an assembly diagram of an implementation of the cable bundle 340, the first circuit board 70, and the second circuit board 280.

As shown in FIG. 43, one end of the cable bundle 340 is connected to the first circuit board 70, and is electrically connected to the first circuit board 70. The other end of the cable bundle 340 is connected to the second circuit board 280, and is electrically connected to the second circuit board 280. Refer to FIG. 13 and FIG. 14. It can be learned that the feedback microphone 40, the speaker 30, the first capacitive sensor 60, and the vibrate pickup sensor 50 in the first earphone body 100 are all electrically connected to the first circuit board 70. Refer to FIG. 30 and FIG. 31. It can be learned that the second circuit board 280 is electrically connected to the mainboard 260. In this way, signals of the feedback microphone 40, the speaker 30, the first capacitive sensor 60, and the vibrate pickup sensor 50 in the first earphone body 100 may be transmitted to the mainboard 260 of the second earphone body 200 through the cable bundle 340. The cable bundle 340 may be configured to transmit an electrical signal between the first earphone body 100 and the second earphone body 200.

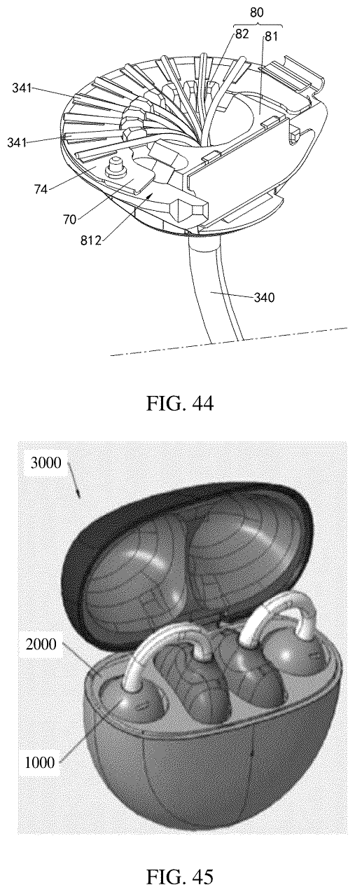

FIG. 44 is an assembly diagram of an implementation of the cable bundle 340, the first circuit board 70, and the cable bundle bracket 80.

As shown in FIG. 44, the cable bundle bracket 80 may include the bracket body 81 and the plurality of baffle plates 82. The fourth part 74 of the first circuit board 70 is fastened to the bottom surface 812 of the bracket body 81. When the cable bundle 340 includes the plurality of signal lines 341, the plurality of signal lines 341 may pass through the cable threading channel 83 of the cable bundle bracket 80, enter a side of the bottom surface 812 of the bracket body 81, and then are electrically connected to the fourth part 74 of the first circuit board 70. The plurality of signal lines 341 and the plurality of baffle plates 82 are arranged alternately in sequence. In other words, one baffle plate 82 is disposed between two adjacent signal lines 341. The baffle plate 82 may be configured to sort the plurality of signal lines 341, separate the plurality of signal lines 341, and reduce interference between the signal lines 341.

FIG. 45 is a diagram of a structure of an implementation of an audio apparatus 3000 according to this application.

As shown in FIG. 45, this application further provides the audio apparatus 3000. The audio apparatus 3000 includes an earphone 1000 and an earphone case 2000. The earphone is disposed in the earphone case 2000. The earphone case 2000 may be configured to accommodate the earphone 1000. In some implementations, the earphone case 2000 may be further configured to charge the earphone 1000.

In some implementations, the audio apparatus 3000 may include two earphones 1000.

It should be noted that embodiments in this application and features in embodiments may be combined with each other without a conflict, and any combination of features in different embodiments also falls within the protection scope of this application. In other words, the foregoing described plurality of embodiments may be further combined based on an actual requirement.

It should be noted that all the foregoing accompanying drawings are example figures of this application, and do not represent actual sizes of products. In addition, a size proportional relationship between components in the accompanying drawings is not intended to limit an actual product in this disclosure.

The foregoing descriptions are merely specific implementations and are not intended to limit the protection scope of this disclosure. Any variation or replacement readily determined by a person skilled in the art within the technical scope disclosed in this disclosure is intended to fall within the protection scope of the accompanying claims.

What is claimed is:

1. An audio apparatus, comprising:
an earphone case; and
an earphone receivable within the earphone case the earphone comprising:
a first earphone body;
a second earphone body; and
a connecting arm connected to the first earphone body and to the second earphone body, the connecting arm positioning the first earphone body and the second earphone body generally opposed from one another, wherein:
the first earphone body comprises a housing and a speaker, the housing including a second connecting hole that connects the first earphone body with the connecting arm, the housing defining an inner surface to which the speaker is secured and a first space that is separated by the speaker into a first sub-cavity and a second sub-cavity;
the speaker includes a sound-emitting surface that faces the first sub-cavity;
the housing comprises a first through hole connecting an outer space of the first earphone body to the first sub-cavity, the first through hole is configured to transmit sound emitted by the speaker out of the first earphone body,
the housing further comprising first and second vent holes that connect the second sub-cavity to the outside of the first earphone body, the first and second vent holes being positioned on opposite sides of the second connecting hole respectively; and
a center of an outer surface of the first earphone body, a center of an outer surface of the second earphone body, and a center of an outer surface of the connecting arm are connected to each other to form a symmetry plane that passes through the first through hole, the first and second vent holes are symmetrically disposed with respect to the symmetry plane.

2. The audio apparatus according to claim 1, wherein:
the first through hole and one of the first and second vent holes form a first line, the first through hole and the second connecting hole form a second line, and the first line and the second line form an angle;
the speaker includes a voice coil, a diaphragm, a first magnet and a second magnet, the voice coil is connected to the diaphragm on the side of the diaphragm away from the first through hole;
a gap is formed between the first magnet and the second magnet;
the voice coil is disposed in the gap; and
the first magnet includes a hole, one side of the hole faces the diaphragm, another side of the hole faces the second connecting hole, and the second line passes through the hole in the speaker.

3. The audio apparatus according to claim 1, wherein the vent holes are positioned between the maximum diameter interface of the first housing and the second connecting hole.

4. The audio apparatus according to claim 1, wherein each of the first and second vent holes is elongated, and the extension direction of the length of each vent hole is perpendicular to the second line.

5. The audio apparatus according to claim 1, wherein the combined area of the first and second vent holes is smaller than the area of the first through hole.

6. The audio apparatus according to claim 1, wherein total area of the first and second vent holes is in the range of 1 mm² to 3 mm².

7. The audio apparatus according to claim 1, wherein area of the first through hole is in the range of 5 mm² to 8 mm².

8. An audio apparatus, comprising:
an earphone case; and
an earphone receivable within the earphone case, the earphone comprising:
a first earphone body;
a second earphone body comprising an antenna module and a mainboard;
a connecting arm connected to the first earphone body and to the second earphone body, the connecting arm positioning the first earphone body and the second earphone body generally opposed from one another, wherein:
the antenna module includes a main unit, a parasitic unit, a feeding line, and a grounding line, the main unit and the parasitic unit being spaced apart from one another;
one end of the feeding line is connected to the main unit, and another end of the feeding line is connected to the mainboard, the parasitic unit is excited through a capacitance coupling with the main unit upon receipt of a signal;
one end of the grounding line is connected to the parasitic unit, and another end of the grounding line is connected to the mainboard;
a center of an outer surface of the first earphone body, a center of an outer surface of the second earphone body, and a center of an outer surface of the connecting arm are connected to each other to form a symmetry plane; and
the main unit and the parasitic unit are symmetrical with respect to the symmetry plane.

9. The audio apparatus according to claim 8, wherein:
one end of the main unit is connected to the feeding line and another end of the main unit is spaced from the parasitic unit; and
one end of the parasitic unit is spaced from the main unit and another end of the parasitic unit is connected to the grounding line.

10. The audio apparatus according to claim 8, wherein:
the second earphone body comprises a third housing and a fourth housing, the third housing being connected to the fourth housing to enclose a second space;
the antenna module and the mainboard are disposed in the second space;
the fourth housing is disposed between the third housing and the first earphone body; and
the antenna module is fastened to the inner surface of the third housing.

11. The audio apparatus according to claim 10, wherein:
the inner surface of the third housing includes a first positioning pillar formed by protruding the inner surface;
the antenna module includes a positioning hole; and
the first positioning pillar is at least partially received in the positioning hole.

12. The audio apparatus according to claim 8, wherein:
the antenna module comprises a packaging structure and an antenna structure; and
the antenna structure is embedded in the packaging structure and comprises the main unit, the parasitic unit, the feeding line, and the grounding line.

13. The audio apparatus according to claim 8, the main unit is monopole antenna.

14. The audio apparatus according to claim 8, wherein the width of the feeding line is smaller than the width of the main unit.

15. The audio apparatus according to claim 8, the antenna module is flexible printed circuit antenna.

16. The audio apparatus according to claim 8, a distance between the main unit and the parasitic unit is 0.5 mm.

17. The audio apparatus according to claim 8, a length L of the antenna module is 13.8 mm.

18. The audio apparatus according to claim 8, a width W of the antenna module is 5.9 mm.

19. The audio apparatus according to claim 8, wherein:
the connecting arm comprises a first end part and a second end part that are spaced from each other;
the first end part is connected to the first earphone body, and the second end part is connected to the second earphone body; and
a central axis direction of the first end part and a central axis direction of second end part are arranged at an angle ranging from 11.4° to 26°.

20. The audio apparatus according to claim 8, wherein an external contour of the first earphone body is receivable within a concha cavity of an ear of a user, and the second earphone body is positioned on an opposite side of the ear away from the first earphone body.
